(19) United States
(12) Patent Application Publication
(10) Pub. No.: US 2025/0105769 A1
(43) Pub. Date: Mar. 27, 2025

(54) MOTOR DRIVE CONTROL DEVICE AND INITIAL POSITION DETECTION METHOD FOR A ROTER

(71) Applicant: MINEBEA MITSUMI Inc., Kitasaku-gun (JP)

(72) Inventors: Hidetoshi HIJIKATA, Kitasaku-gun (JP); Hiroki KOKUBO, Kitasaku-gun (JP); Shinji TOTSUKA, Kitasaku-gun (JP); Shigemi MASUDA, Kitasaku-gun (JP)

(21) Appl. No.: 18/883,136

(22) Filed: Sep. 12, 2024

(30) Foreign Application Priority Data
Sep. 21, 2023 (JP) 2023-156257

(51) Int. Cl. H02P 21/18; H02P 21/22; H02P 25/022; H02P 27/08

(52) U.S. Cl. CPC H02P 21/18; H02P 21/22; H02P 25/022; H02P 27/08; H02P 2207/055

(57) ABSTRACT

A control circuit that generates a drive control signal, an inverter circuit including a switch provided corresponding to the coil of each-phase of the motor, a driving circuit that rotates the rotor of the motor by alternately turning on/off the switch in accordance with the drive control signal, a shunt resistance provided between the inverter circuit and a ground, and a bidirectional current detection circuit that detects the current flowing through the shunt resistance in both directions are provided. The control circuit performs energization and interruption in the energization direction of the coil by sequentially switching the energization sectors without rotating the rotor of the motor, and estimates the position of the rotor based on the peak value of the energization current and the peak value of the kickback current due to the inductive kickback for each energization sector.

### CROSS-REFERENCE TO RELATED APPLICATIONS

This application claims the benefit of priority to Japanese Patent Application Number 2023-156257 filed on Sep. 21, 2023. The entire contents of the above-identified application are hereby incorporated by reference.

### TECHNICAL FIELD

The present invention relates to a motor drive control device and a motor drive control method.

### BACKGROUND ART

A method of detecting the magnetic pole position (initial position) of the rotor by using the difference in time or current due to the influence of the magnetic saturation of the coil for each energization direction in such a manner that “time to reach specified current” or “largest current in specified time” is measured by exciting the winding through energization for each of energizations of six directions through 1-phase excitation or 1-2-phase excitation as the rotor initial position detection of a stopped motor in a position sensorless type 3-phase brushless dc motor (BLDC motor) is known (Patent Documents 1, 2, and 3).

### CITATION LIST

### Patent Literature

Patent Document 1: JP 2010-41881 A

Patent Document 2: JP 2016-19454 A

Patent Document 3: JP 2021-164191 A

### SUMMARY OF INVENTION

### Technical Problem

In the known detection method for the rotor magnetic pole position, in the case of a surface permanent magnet synchronous motor (SPMSM) with a small thrust polarity, the influence of the magnetic saturation of the coil is small and the rotor position is not uniquely set in the range of 60 degrees (energization sector) when the current is small, whereas when the current is large, the rotor position is set by the magnetic saturation of the coil, but generation of a magnetic sound “clunk” resulting from energization and unintentional rotation of the rotor may result. In addition, if the resolution of the current measurement is low, it is difficult to detect the magnetic pole position of the rotor due to the small difference obtained through measurement.

The present inventors studied the above-mentioned problems intensively, and found that the rotor initial position detection can be achieved in a short time with a low-resolution current measurement device without increasing the energization current to increase the difference in current measured in a specified time for each energization direction by using a bidirectional current detection circuit and using both the energization current flowing in the ground direction during energization and the kickback current flowing in the inverter circuit direction during interruption due to the inductive kickback in current measurement of a 1-shunt system, and that by starting the next energization after the kickback current is converged to zero, the correct current measurement can be performed and the measurement time of the energizations of six directions is reduced, thus achieving the present invention.

To solve the above-described problems, an object of the present invention is to provide a motor drive control device that can achieve the rotor initial position detection in a short time with a low-resolution current measurement device.

### Solution to Problem

A motor drive control device according to a representative embodiment of the present invention includes a control circuit configured to generate a drive control signal for driving a motor including at least a coil of one phase; a driving circuit including an inverter circuit including a high-side switch and a low-side switch connected in series and provided corresponding to a coil of each phase of the motor, the driving circuit being configured to rotate a rotor of the motor by switching an energization direction of the coil of corresponding phase by alternately turning on/off the high-side switch and the low-side switch in accordance with the drive control signal; a shunt resistance provided between the inverter circuit and a ground; and a bidirectional current detection circuit configured to detect a current flowing through the shunt resistance, in both a ground direction that is a direction from the inverter circuit to the ground, and in an inverter circuit direction that is a direction opposite to the ground direction. The control circuit generates an initial position detection signal for performing energization and interruption in an energization direction of the coil corresponding to an energization sector by turning on/off the high-side switch and the low-side switch of the inverter circuit so as to sequentially switch the energization sector without rotating the rotor of the motor, acquires a peak value of an energization current that flows in the ground direction upon the energization and a peak value of a kickback current due to an inductive kickback that flows in the inverter circuit direction upon interruption of the energization for each energization sector, based on a current detected by the bidirectional current detection circuit when the initial position detection signal is generated, and estimates a position of the rotor based on the peak value of the energization current and the peak value of the kickback current for each energization sector.

### Advantageous Effects of Invention

According to an aspect of the present invention, the rotor initial position detection can be achieved in a short time with a low-resolution current measurement device.

### BRIEF DESCRIPTION OF DRAWINGS

FIG. 1 is a diagram illustrating a configuration of a motor unit 100 including a motor drive control device 10 according to the embodiment.

FIG. 2 is a diagram illustrating an example of a configuration of a current detection circuit 22 of the motor drive control device 10.

FIG. 3 is a diagram illustrating a switch state of an inverter circuit 2a and a current vector in each energization sector of a motor 3 of the three phase type.

FIG. 4 is a diagram illustrating a specific direction of a current vector.

FIG. 5 is a diagram for describing a switch state corresponding to a free mode that is switched by an idling control signal Id.

FIG. 6 is a diagram for describing a switch state corresponding to a charging mode that is switched by the idling control signal Id.

FIG. 7 is a diagram for describing a switch state corresponding to a discharge mode that is switched by the idling control signal Id.

FIG. 8 is a diagram illustrating a functional block configuration in a control circuit 1 of the motor drive control device 10 according to the embodiment.

FIG. 9 is a diagram illustrating an example of a configuration of a current measurement section 16 included in the control circuit 1 of the motor drive control device 10.

FIG. 10 is a timing diagram illustrating an example of a signal waveform from input of a speed command signal Sc to completion of rotor idling detection in the case where the rotor of the motor 3 is not moving at all.

FIG. 11 is a timing diagram illustrating an example of a signal waveform from input of the speed command signal Sc to completion of rotor idling detection in the case where the rotor of the motor 3 is moving.

FIG. 12 is a timing diagram illustrating an example of a signal waveform in the case where the speed command signal Sc is input after power-on of the motor unit 100, and then a stoppage of the rotor is confirmed, and thereafter, the rotor initial position detection is completed.

FIG. 13 is another timing diagram illustrating an example of a signal waveform in the case where the speed command signal Sc is input after power-on of motor unit 100, and then a stoppage of the rotor is confirmed, and thereafter, the rotor initial position detection is completed.

FIG. 14 is another timing diagram illustrating an example of a signal waveform of energization/interruption for one energization sector in the rotor initial position detection in the case where the speed command signal Sc is input after power-on of motor unit 100, and then a stoppage of the rotor confirmed.

FIG. 15 is a flowchart illustrating an example of the flow of the process at the time of power-on at the control circuit 1 of the motor drive control device 10 according to the embodiment.

FIG. 16 is a flowchart illustrating an example of the flow of the offset measurement performed by the control circuit 1 of the motor drive control device 10.

FIG. 17 is a flowchart illustrating an example of the flow of the rotor stoppage waiting by the control circuit 1 of the motor drive control device 10.

FIG. 18 is a flowchart illustrating an example of the flow of the rotor initial position measurement by the control circuit 1 of the motor drive control device 10.

FIG. 19 is a flowchart illustrating an example of the flow of the rotor initial position measurement in energization sector n by the control circuit 1 of the motor drive control device 10.

### DESCRIPTION OF EMBODIMENTS

### 1. Overview of Embodiments

First, an overview of typical embodiments of the invention disclosed in the present application will be described. Note that in the following description, by way of example, reference numerals on the drawings corresponding to the components of the invention are indicated in parentheses.

[1] A motor drive control device (10) according to a representative embodiment of the present invention includes: a control circuit (1) configured to generate a drive control signal (Sd) for driving a motor (3) including at least a coil of one phase; a driving circuit (2) including an inverter circuit (2a) including a high-side switch (Q1, Q3, Q5) and a low-side switch (Q2, Q4, Q6) connected in series and provided corresponding to a coil of each phase of the motor, the driving circuit (2) being configured to rotate a rotor of the motor by switching an energization direction of the coil of corresponding phase by alternately turning on/off the high-side switch and the low-side switch in accordance with the drive control signal (Sd); a shunt resistance (Rs) provided between the inverter circuit and a ground; and a bidirectional current detection circuit (30) configured to detect a current flowing through the shunt resistance, in both a ground direction that is a direction from the inverter circuit to the ground, and in an inverter circuit direction that is a direction opposite to the ground direction. The control circuit generates an initial position detection signal (Pd) for performing energization and interruption in an energization direction of the coil corresponding to an energization sector by turning on/off the high-side switch and the low-side switch of the inverter circuit so as to sequentially switch the energization sector without rotating the rotor of the motor, acquires a peak value of an energization current that flows in the ground direction upon the energization and a peak value of a kickback current due to an inductive kickback that flows in the inverter circuit direction upon interruption of the energization for each energization sector, based on a current detected by the bidirectional current detection circuit when the initial position detection signal is generated, and estimates a position of the rotor based on the peak value of the energization current and the peak value of the kickback current for each energization sector.

[2] In the motor drive control device according to [1], the control circuit may include: an initial position detection signal generation section (131) configured to generate the initial position detection signal that is input to the inverter circuit to sequentially perform energization and interruption in the energization direction of the coil for each energization sector, a peak current acquiring section (132) configured to acquire the peak value of the energization current and the peak value of the kickback current for each energization sector, and a position estimation section (133) configured to estimate the position of the rotor based on the peak value of the energization current and the peak value of the kickback current for each energization sector.

[3] In the motor drive control device according to [2], the initial position detection signal generation section may generate the initial position detection signal for performing energization of a next energization sector after it is confirmed that a magnitude of the kickback current has converged to zero.

[4] In the motor drive control device according to [2], the peak current acquiring section may acquire the peak value of the energization current, and acquires the kickback current after a mask time has elapsed.

[5] In the motor drive control device according to [2], the position estimation section may perform comparison of a total current value of the energization current and the kickback current for each energization sector, and estimate a position corresponding to the energization sector with a maximum total current value as the position of the rotor.

[6] In the motor drive control device according to [5], when there are two or more energization sectors with the maximum total current value, the position estimation section may acquire an energization sector with a maximum peak value of the energization current flowing in the ground direction and an energization sector with a maximum peak value of the kickback current due to the inductive kickback flowing in the inverter circuit direction, and estimate the position of the rotor in accordance with the number of energization sectors acquired.

[7] In the motor drive control device according to [5], when there are two or more energization sectors with the maximum total current value, the position estimation section may further acquire, for each energization sector, differences in current of three bidirectional energizations from a total current value that is a current value of a sum of a magnitude of the peak value of the energization current flowing in the ground direction and a magnitude of the peak value of the kickback current due to the inductive kickback flowing in the inverter circuit direction, and when there is one maximum value of the differences in current between three bidirectional energizations, it is estimated that the position of the rotor is located at a position corresponding to an energization sector with a larger total current value among two energization sectors of bidirectional energization with the maximum value of the differences in current.

[8] In the motor drive control device according to [2], the initial position detection signal generation section may generate the initial position detection signal set to perform the energization in the energization direction of the coil corresponding to the energization sector by dividing the energization into a plurality of predetermined number of times.

[9] In the motor drive control device according to [2], the initial position detection signal generation section may generate the initial position detection signal set to turn on a switch that has a complementary relationship with respect to an energization state, among a high-side switch and a low-side switch of the inverter circuit at a timing of interruption in the energization sector.

[10] In the motor drive control device according to [1], the control circuit may further include: a first switching section (121a) configured to switch a state from a first switch state where all of the high-side switch and the low-side switch included in the inverter circuit are turned off, to a second switch state where at least two of the high-side switch or the low-side switch included in the inverter circuit are turned on, a second switching section (121b) configured to switch a state from the second switch state to the first switch state, and an idling determination section (122) configured to determine that the rotor of the motor is idling based on a current flowing through the shunt resistance when the state is switched from the second switch state to the first switch state, wherein the control circuit generates the initial position detection signal after it is confirmed at the idling determination section that the rotor of the motor is not idling.

[11] In the motor drive control device according to [10], the control circuit (1) may further include a position estimation section configured to estimate the position of the rotor based on the peak value of the energization current and the peak value of the kickback current for each energization sector, and the control circuit (1) may further include a current measurement section configured to preliminarily detect, as an offset, an output signal from the bidirectional current detection circuit in a state where no current flows through the shunt resistance, and adjust, with the offset, a signal that is output from the bidirectional current detection circuit in determination of the idling and estimation of the position of the rotor to output the signal to the idling determination section and the position estimation section.

[12] An initial position detection method according to a representative embodiment of the present invention is a method for a rotor configured to be executed in a motor drive control device including: a control circuit configured to generate a drive control signal for driving a motor including at least a coil of one phase; a driving circuit including an inverter circuit including a high-side switch and a low-side switch connected in series and provided corresponding to a coil of each phase of the motor, the driving circuit being configured to rotate a rotor of the motor by switching an energization direction of the coil of corresponding phase by alternately turning on/off the high-side switch and the low-side switch in accordance with the drive control signal; a shunt resistance provided between the inverter circuit and a ground; and a bidirectional current detection circuit configured to detect a current flowing through the shunt resistance, in both a ground direction that is a direction from the inverter circuit to the ground, and in an inverter circuit direction that is a direction opposite to the ground direction, the method comprising: a first step of generating an initial position detection signal for performing energization and interruption in an energization direction of the coil corresponding to an energization sector by turning on/off the high-side switch and the low-side switch of the inverter circuit so as to sequentially switch the energization sector without rotating the rotor of the motor, a second step of acquiring a peak value of an energization current that flows in the ground direction upon the energization and a peak value of a kickback current due to an inductive kickback that flows in the inverter circuit direction upon interruption of the energization for each energization sector, based on a current detected by the bidirectional current detection circuit when the initial position detection signal is generated, and a third step of estimating a position of the rotor based on the peak value of the energization current and the peak value of the kickback current for each energization sector.

### 2. Specific Examples of Embodiments

Hereinafter, specific examples of embodiments of the present invention will be described with reference to the drawings. In the following description, the components common to the embodiments are denoted by the same reference signs, and repeated descriptions are omitted.

### Embodiments

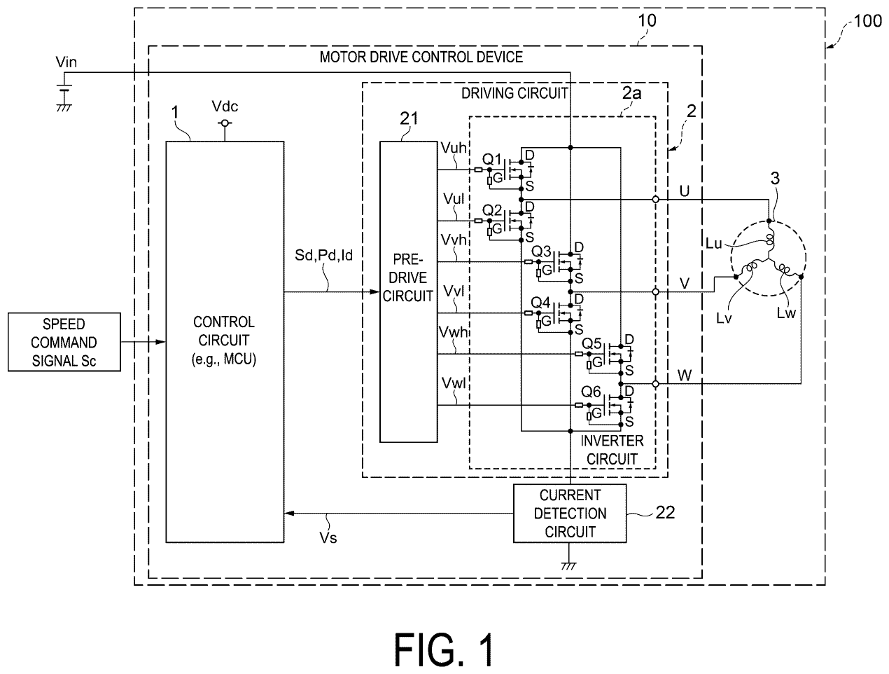

FIG. 1 is a diagram illustrating a configuration of a motor unit 100 including a motor drive control device 10 according to the embodiment.

As illustrated in FIG. 1, the motor unit 100 includes a motor 3, and the motor drive control device 10 that controls the rotation of the rotor of the motor 3. The motor unit 100 is applicable to various devices that use a motor as a driving source such as fans and drones (unmanned aerial vehicles), for example.

The motor 3 is a permanent magnet synchronization motor (PMSM), for example. In the present embodiment, the motor 3 is a surface magnet synchronous motor (SPMSM) including coils (windings) of three phases, Lu, Lv, and Lw, for example. The coils Lu, Lv, and Lw are Y (star) wired to each other. In this case, the coils may be Δ (delta) wired to each other.

The motor drive control device 10 rotates the rotor of the motor 3 by periodically applying a sinusoidal drive current to the coils of three phases Lu, Lv, and Lw of the motor 3 by providing sinusoidal driving signals to the motor 3, for example.

The motor drive control device 10 includes a control circuit 1, a driving circuit 2 and a current detection circuit 22.

Note that the components of the motor drive control device 10 illustrated in FIG. 1 are part of the whole, and the motor drive control device 10 may include other components in addition to the components illustrated in FIG. 1.

The driving circuit 2 drives the motor 3 on the basis of a drive control signal Sd output from the control circuit 1 described later. The driving circuit 2 includes an inverter circuit 2a and a pre-drive circuit 21, for example. The current detection circuit 22 is provided between the inverter circuit 2a of the driving circuit 2 and the ground.

The inverter circuit 2a is a circuit disposed between a direct current power source Vin and the ground potential, and drives the coils Lu, Lv and Lw of the motor 3 as a load on the basis of the input drive control signal Sd. More specifically, in the above-mentioned embodiment, the inverter circuit 2a includes three switching legs including two drive transistors connected in series, and drives the motor 3 as a load with the two drive transistors alternately performing on/off operation (switching operation) on the basis of the input drive control signal Sd.

More specifically, the inverter circuit 2a includes switching legs corresponding to the U-phase, V-phase, and W-phase of the motor 3. As illustrated in FIG. 1, the switching legs corresponding to respective phases include two drive transistors (hereinafter referred to also as “switching elements”) Q1 and Q2, Q3 and Q4, and Q5 and Q6 connected in series through the current detection circuit 22 between the direct current power source Vin and the ground potential.

Here, the drive transistors Q1, Q3 and Q5 (corresponding to the high-side switch) of the upper arms of the coils of the motor 3 are N-channel MOSFETs, and the drive transistors Q2, Q4 and Q6 (corresponding to the low-side switch) of the lower arms of the coils of the motor 3 are N-channel MOSFETs, for example. Note that the drive transistors Q1 to Q6 may be other types of FETs, and may be other types of transistors such as an Insulated Gate Bipolar Transistor (IGBT), for example.

For example, the switching leg corresponding to the U-phase includes switching elements Q1 and Q2 mutually connected in series. The common connection point of the switching element Q1 and the switching element Q2 is connected to one end of the coil Lu as a load. The switching leg corresponding to the V-phase includes switching elements Q3 and Q4 mutually connected in series. The common connection point of the switching element Q3 and the switching element Q4 is connected to one end of the coil Lv as a load. The switching leg corresponding to the W-phase includes the switching elements Q5 and Q6 mutually connected in series. The common connection point of the switching element Q5 and the switching element Q6 is connected to one end of the coil Lw as a load. In addition, the switching elements Q1 and Q2, Q3 and Q4, and Q5 and Q6 each has parasitic diode characteristics from the ground side to the power source side direction.

The pre-drive circuit 21 generates a driving signal for driving the inverter circuit 2a on the basis of the drive control signal Sd output from the control circuit 1.

The drive control signal Sd is a signal for controlling driving of the motor 3 and is, for example, a Pulse Width Modulation (PWM) signal. More specifically, the drive control signal Sd is a signal for switching the energization pattern of the coils Lu, Lv and Lw of the motor 3 set by the on/off state of each switching element making up the inverter circuit 2a. More specifically, the drive control signal Sd includes six types of PWM signals corresponding to the switching elements Q1 to Q6 of the inverter circuit 2a.

The pre-drive circuit 21 generates the six types of driving signals Vuh, Vul, Vvh, Vvl, Vwh, and Vwl capable of supplying sufficient power to drive the control electrodes (gate electrodes) of the switching elements Q1 to Q6 of the inverter circuit 2a on the basis of the six types of PWM signals as the drive control signal Sd supplied from the control circuit 1.

When these driving signals Vuh, Vul, Vvh, Vvl, Vwh, and Vwl are input to the control electrodes (gate electrodes) of the switching elements Q1 to Q6 of the inverter circuit 2a, each of the switching elements Q1 to Q6 performs on/off operation (switching operation). For example, the switching elements Q1, Q3, and Q5 of the upper arms of the switching legs corresponding to respective phases and the switching elements Q2, Q4, and Q6 of the lower arms alternately perform on/off operation. In this manner, power is supplied to each phase of the motor 3 from the direct current power source Vin, and the rotor of the motor 3 rotates.

The current detection circuit 22 is connected to the direct current line of the inverter circuit 2a to detect the current flowing through the direct current line. More specifically, it includes one resistance (hereinafter referred to also as “shunt resistance”) Rs serving as a current detection element. The shunt resistance Rs is connected in series to the inverter circuit 2a between the direct current power source Vin and the ground potential, for example. Specifically, as illustrated in FIG. 1, the shunt resistance Rs of the current detection circuit 22 is connected on the negative side (ground side) of the inverter circuit 2a, for example. For example, the winding currents Iu, Iv, and Iw that flow through the coils of three phases Lu, Lv, and Lw of the motor 3 when the inverter circuit 2a is controlled in motor drive flow through the shunt resistance Rs of the current detection circuit 22. The current detection circuit 22 detects the voltage drop due to the current flowing through the shunt resistance Rs from the differential voltage of both ends of the shunt resistance Rs, and outputs a current detection signal Vs corresponding to the current flowing through the shunt resistance Rs to the control circuit 1 as the detection result.

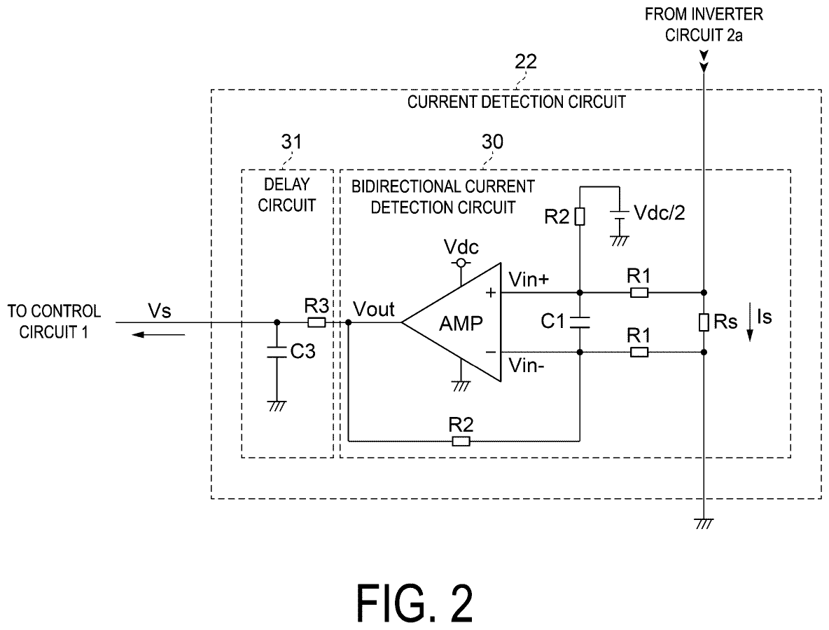

FIG. 2 is a diagram illustrating an example of a configuration of the current detection circuit 22 of the motor drive control device 10. In addition to the shunt resistance Rs, the current detection circuit 22 includes a bidirectional current detection circuit 30 and a delay circuit 31.

The current detection circuit 22 in FIG. 2 outputs the current detection signal Vs corresponding to the current flowing through the shunt resistance Rs.

More specifically, the bidirectional current detection circuit 30 in FIG. 2 acquires the differential voltage at both ends of the shunt resistance Rs, amplifies the voltage by a predetermined gain with an amplifier (AMP) using a differential amplifier circuit, and outputs the voltage as a voltage drop signal Vout at the shunt resistance Rs. The delay circuit 31 smoothens the voltage drop signal Vout with a circuit composed of a resistance R3 and a capacitor C3, and outputs the signal to the control circuit 1 as the current detection signal Vs corresponding to the current flowing through the shunt resistance Rs. The bidirectional current detection circuit 30 is configured to be able to detect the positive and negative voltage drops generated at the shunt resistance Rs, i.e., configured to measure the bidirectional current by applying a voltage Vdc/2 that offsets the output of the amplifier to the positive terminal of the differential amplifier circuit. At this time, the current detection signal Vs outputs a signal in a range from 0 to Vdc that is Vdc/2 when a shunt current Is is zero. Note that the voltage that offsets the output of the amplifier is not limited to Vdc/2, and a voltage that offsets the output of the amplifier may be applied to the negative terminal of the differential amplifier circuit.

With a current measurement section 16 described later, the bidirectional current detection circuit 30 in the current detection circuit 22 can detect at the shunt resistance Rs the shunt current Is that has a positive value in a ground direction (the arrow direction of Is in the drawing) from the inverter circuit 2a toward the ground, and a negative value in the opposite direction of the ground direction, i.e., an inverter circuit direction from the ground toward the inverter circuit 2a.

In the current detection circuit 22, during the drive of the motor 3 with the drive control signal Sd, the current that has flowed through the inverter circuit 2a again via the coils of the motor 3 passes through the shunt resistance Rs. That is, since the current flows through the current detection circuit 22 in the ground direction from the inverter circuit 2a toward the ground, the shunt current Is with a positive value can be measured with the current measurement section 16 described later.

The motor drive control device 10 of the present embodiment is configured to detect the initial position of the rotor when the rotor of the motor 3 is not rotating in addition to the above-described driving of the motor 3 with the drive control signal Sd.

The motor drive control device 10 of the present embodiment detects the initial position of the rotor by estimating the position of the rotor on the basis of the current that flows through the shunt resistance Rs when energization and interruption are performed in the energization direction of the coil corresponding to the energization sector by switching the switch state of each of the switching elements Q1 to Q6 of the inverter circuit 2a in such a manner as to sequentially switch the energization sector without rotating the rotor of the motor 3.

In the motor drive control device 10 of the present embodiment, to detect the initial position of the rotor, the driving circuit 2 receives an initial position detection signal Pd different from the drive control signal Sd for driving the motor from the control circuit 1 described later, and switches each switching element making up the inverter circuit 2a to the switch state for detecting the initial position of the rotor on the basis of the received initial position detection signal Pd. More specifically, energization and interruption are performed in the energization direction of the coil corresponding to the energization sector by turning on/off the high-side switches Q1, Q3, and Q5 and the low-side switches Q2, Q4, and Q6 of the inverter circuit 2a in such a manner as to sequentially switch the energization sector without rotating the rotor of the motor 3 for each switching element making up the inverter circuit 2a on the basis of the initial position detection signal Pd.

The initial position detection signal Pd is a signal for switching each switching element making up the inverter circuit 2a to the switch state for detecting the initial position of the rotor. Unlike the drive control signal Sd for driving the motor, the initial position detection signal Pd is not a signal for rotating the rotor of the motor 3, and therefore is not a signal (PWM signal) that alternately switches on/off each switching element, but is a high-level or low-level signal with a predetermined length, for example. The initial position detection signal Pd includes six types of signals corresponding to the switching elements Q1 to Q6 of the inverter circuit 2a.

The pre-drive circuit 21 generates a driving signal as a switch signal for switching the switch state of each switching element making up the inverter circuit 2a on the basis of the initial position detection signal Pd output from the control circuit 1.

On the basis of the six types of signals as the initial position detection signal Pd supplied from the control circuit 1, the pre-drive circuit 21 generates a signal capable of supplying power enough to switch the switch state of the control electrode (gate electrode) of each of the switching elements Q1 to Q6 of the inverter circuit 2a. When driving signals as these switch signals are input to the control electrodes (gate electrodes) of the switching elements Q1 to Q6 of the inverter circuit 2a, the switch state of each of the switching elements Q1 to Q6 is switched.

Now sequential switching of the energization sector without rotating the rotor of the motor 3 is described below.

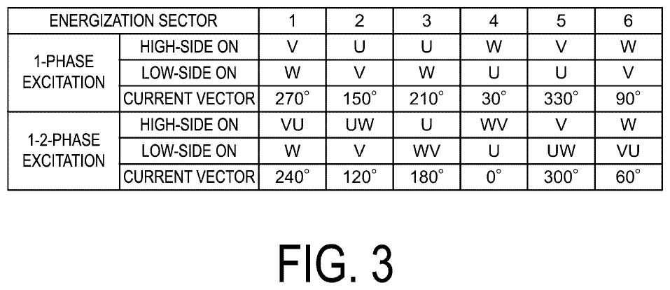

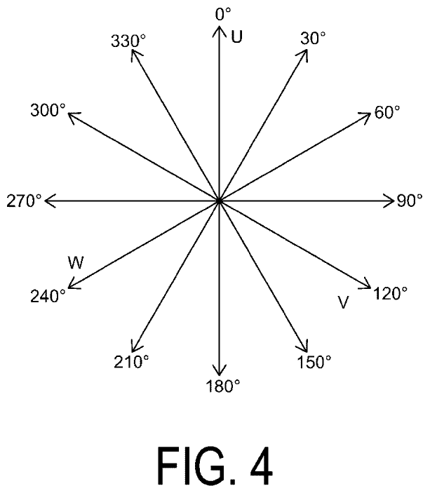

FIGS. 3 and 4 are diagrams for describing an energization sector in the motor 3. FIG. 3 is a diagram illustrating a current vector and a switch state of the inverter circuit 2a in each energization sector of the 3-phase motor 3, and FIG. 4 is a diagram illustrating a specific direction of a current vector.

As illustrated in FIG. 3, in the case of the 3-phase motor 3, there are six energization sectors at 60 degrees. The sector is sequentially switched to one of the six energization sectors on the basis of the initial position detection signal Pd.

As illustrated in FIG. 3, in the case of 1-phase excitation energization system, the V-phase high-side switching element Q3 and the W-phase low-side switching element Q6 are turned on and the current vector is set to the direction of 270° in an energization sector 1. Likewise, the U-phase high-side switching element Q1 and the V-phase low-side switching element Q4 are turned on and the current vector is set to the direction of 150° in an energization sector 2, the U-phase high-side switching element Q1 and the W-phase low-side switching element Q6 are turned on and the current vector is set to the direction of 210° in an energization sector 3, the W-phase high-side switching element Q5 and the U-phase low-side switching element Q2 are turned on and the current vector is set to the direction of 30° in an energization sector 4, the V-phase high-side switching element Q3 and the U-phase low-side switching element Q2 are turned on and the current vector is set to the direction of 330° in an energization sector 5, and the W-phase high-side switching element Q5 and the V-phase low-side switching element Q4 are turned on and the current vector is set to the direction of 90° in an energization sector 6.

As illustrated in FIG. 3, in the case of the 1-2-phase excitation energization system, the V- and U-phase high-side switching elements Q3 and Q1 and the W-phase low-side switching element Q6 are turned on and the current vector is set to the direction of 240° in the energization sector 1, the U- and W-phase high-side switching elements Q1 and Q5 and the V-phase low-side switching element Q4 are turned on and the current vector is set to the direction of 120° in the energization sector 2, the U-phase high-side switching element Q1 and the W- and V-phase low-side switching elements Q6 and Q4 are turned on and the current vector is set to the direction of 180° in the energization sector 3, the W- and V-phase high-side switching elements Q5 and Q3 and the U-phase low-side switching element Q2 are turned on and the current vector is set to the direction of 0° in the energization sector 4, the V-phase high-side switching element Q3 and the U- and W-phase low-side switching elements Q2 and Q6 are turned on and the current vector is set to the direction of 300° in the energization sector 5, and the W-phase high-side switching element Q5 and the V- and U-phase low-side switching element Q4 and Q2 are turned on and the current vector is set to the direction of 60° in the energization sector 6. Note that in the present embodiment, a case of the 1-2-phase excitation energization system is described below as an example.

FIG. 3 shows that when the energization sector is switched to one of the six energization sectors, the current vector is switched to any one of the directions illustrated in FIG. 4.

In a normal motor drive, with the drive control signal Sd for driving the motor, the energization sector is switched such that the current vector gradually rotates on a 60-degree basis. For example, the switching element is energized by switching the energization sector in the order of the energization sector 3, the energization sector 1, the energization sector 5, the energization sector 4, the energization sector 6, and the energization sector 2. While the order of the energization sector is reversed in the case where the rotational direction of the motor reversed, the energization sectors are sequentially switched without rotating the rotor of the motor 3 in the rotor initial position detection, and therefore the energization sector is switched such so as to cancel the current vector. For example, the energization sectors are switched in the order of the energization sector 3, the energization sector 4, the energization sector 6, the energization sector 1, the energization sector 5, and the energization sector 2. Note that for example, the energization sector 3 and the energization sector 4 may be handled as bidirectional energization because the current vectors are opposite.

In addition, in the rotor initial position detection, energization in the energization sector is performed for a predetermined magnetic saturation time. Now the magnetic saturation time is described. When the coils of the motor 3 are energized, a magnetic field is gradually generated at the coils in accordance with the duration of the energization time. However, the generated magnetic field is limited by the relationship of the magnetic pole positions of the rotor and the stator, and the coil state where the generated magnetic field has reached the limit is referred to as a state where the magnetic saturation has been reached. When the magnetic pole positions of the rotor and the stator have a constant relationship, the speed to reach the magnetic saturation is high due to synergistic effects. The time taken to reach the magnetic saturation when the magnetic pole positions of the rotor and the stator have a constant relationship is defined as a predetermined magnetic saturation time, the predetermined magnetic saturation time is set for the energization time in the energization sector. As such, in the energization sectors at positions other than the position where the magnetic pole positions of the rotor and the stator have a constant relationship, the speed to reach the magnetic saturation is low, and therefore the magnetic saturation does not occur in “the predetermined magnetic saturation time”. The predetermined magnetic saturation time may not be exactly the same as the time taken for reaching the magnetic saturation of the case where the magnetic pole positions of the rotor and the stator have a constant relationship, and may be adjusted as long as it is possible to discern from positions where the magnetic pole positions of the rotor and the stator have a constant relationship. When this magnetic saturation is reached, a large current flows through the coil, and thus the rotor initial position detection can be achieved by measuring “largest current in specified time”.

Next, the following describes how the initial position of the rotor can be detected by estimating the position of the rotor on the basis of the current that flows through the shunt resistance Rs when energization and interruption are performed in the energization direction of the coil corresponding to the energization sector.

As described above, during energization of the coil of the motor 3, the shunt current Is flows in the ground direction at the shunt resistance Rs of the current detection circuit 22 as when the motor is driven. In the related art, the position of the rotor is estimated based on the peak current value of this shunt current Is. On the other hand, the motor drive control device 10 of the present embodiment focuses on the fact that a kickback current due to the inductive kickback flowing in the inverter circuit direction is generated at the shunt resistance Rs of the current detection circuit 22 when energization is interrupted, and measures this current as a negative value of the shunt current Is.

In each energization sector, when interruption is performed after energization in the energization direction of the coil, the current acts to continuously flow in the energization direction of the coil. For the coil, this current is in the same direction as during energization, but for the shunt resistance Rs, the current is in the inverter circuit direction opposite to the ground direction during energization. The peak of the magnitude is substantially the same magnitude as the peak value of the energization current. That is, for the energization sector where magnetic saturation has been generated at the coil, the magnitude of the peak value of the kickback current that is detected in the opposite inverter circuit direction is greater than in other energization sectors as with the magnitude of the peak value of the energization current that is detected in the ground direction of the shunt resistance Rs. This shows that not only the peak value of the energization current of each energization sector, but also the peak value of the kickback current can be used for estimating the position of the rotor.

In this manner, in the motor drive control device 10 of the present embodiment, the bidirectional current detection circuit 30 is used as the current detection circuit 22 to estimate the position of the rotor on the basis of the peak value of the kickback current and the peak value of the energization current for each energization sector. Since the range of the current value to be detected increases during estimation of the position of the rotor, the difference in current measured by energization for a specified time for each energization sector increases, and the initial position of the rotor can be more accurately detected with a small current without increasing energization current to increase the difference in current measured in a specified time for each energization direction. Thus, the motor drive control device 10 of the present embodiment can use detection devices with low resolution. The difference between the magnitudes of the peak value of the kickback current and the peak value of the energization current for each energization sector occurs also in the case of a coil of one phase with switching elements on the upper and lower sides at both ends of the coil.

In the motor drive control device 10 of the present embodiment, the initial position detection of the rotor is required to be performed in the state where the rotor of the motor 3 is not idling because the initial position detection of the rotor measures the current due to energization in a specified time. Specifically, in the motor drive control device 10 of the present embodiment, it is necessary to perform a rotor stoppage waiting process before executing the initial position detection of the rotor. In this case, it is possible to provide a configuration of determining the idling of the rotor of the motor 3 when the motor 3 is not driven by the drive control signal Sd, in addition to driving the motor 3 by the drive control signal Sd and the initial position detection of the rotor by the initial position detection signal Pd described above. With the configuration of determining the idling of the rotor, the motor drive control device 10 of the present embodiment can perform the initial position detection of the rotor after confirming that the rotor of the motor 3 is not idling.

In the motor drive control device 10 of the present embodiment, it is determined that the rotor of the motor 3 is idling on the basis of the kickback current flowing through the shunt resistance Rs due to the inductive kickback that is generated at the inverter circuit 2a when the current path is blocked after an induced current circulating between the coil of the motor 3 and the inverter circuit 2a is generated with an induced electromotive force in the case where the rotor of the motor 3 is rotated by switching the switch state of each of the switching elements Q1 to Q6 of the inverter circuit 2a.

In the motor drive control device 10 of the present embodiment, to detect the idling of the rotor of the motor 3, the driving circuit 2 receives an idling control signal Id different from the drive control signal Sd for driving the motor from the control circuit 1 described later, and switches each switching element making up the inverter circuit 2a to a switch state for detecting the idling of the rotor of the motor 3 on the basis of the received idling control signal Id. More specifically, each switching element making up the inverter circuit 2a is switched to a switch state corresponding to three modes (a free mode, a charging mode, and a discharge mode) on the basis of the idling control signal Id. The three modes for detecting the idling of the rotor of the motor 3 are described later.

The idling control signal Id is a signal for switching each switching element making up the inverter circuit 2a to a switch state corresponding to the three modes for detecting the idling of the rotor of the motor 3. Unlike the drive control signal Sd for driving the motor, the idling control signal Id is not a signal for applying a drive voltage to the coils of the motor 3, and therefore is not a signal that alternately switches on/off each switching element, but is a high-level or low-level signal with a predetermined length, for example. The idling control signal Id includes six types of signals corresponding to the switching elements Q1 to Q6 of the inverter circuit 2a.

The pre-drive circuit 21 generates a driving signal as a switch signal for switching the switch state of each switching element making up the inverter circuit 2a on the basis of the idling control signal Id output from the control circuit 1.

The pre-drive circuit 21 generates a signal capable of supplying power sufficient to switch the switch state of the control electrode (gate electrode) of each of the switching elements Q1 to Q6 of the inverter circuit 2a on the basis of the six types of signals as the idling control signal Id supplied from the control circuit 1. When driving signals as these switch signals are input to the control electrodes (gate electrodes) of the switching elements Q1 to Q6 of the inverter circuit 2a, the switch state of each of the switching elements Q1 to Q6 is switched.

Now the switch states that are switched by the idling control signal Id, and correspond to the three modes for detecting the idling of the rotor of the motor 3 (the free mode, the charging mode, the discharge mode) are described below.

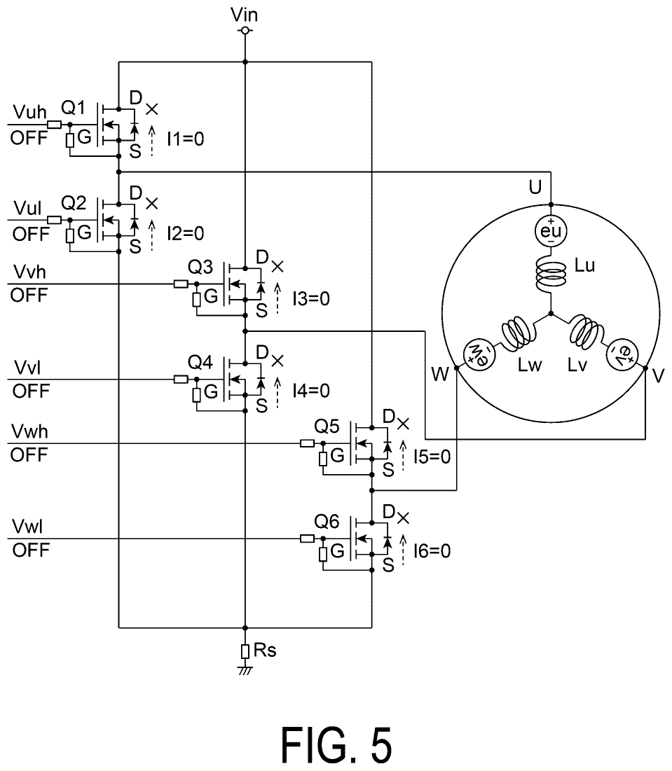

FIGS. 5 to 7 are diagrams for describing each switch state switched by the idling control signal Id. In FIGS. 5 to 7, the arrow indicates a state of a current that flows when the rotor of the motor 3 is idling in the coils of the motor 3 and the inverter circuit 2a. The inverter circuit 2a is connected to the direct current power source Vin, and connected to the ground through the shunt resistance Rs, the shunt resistance being a part of the current detection circuit 22.

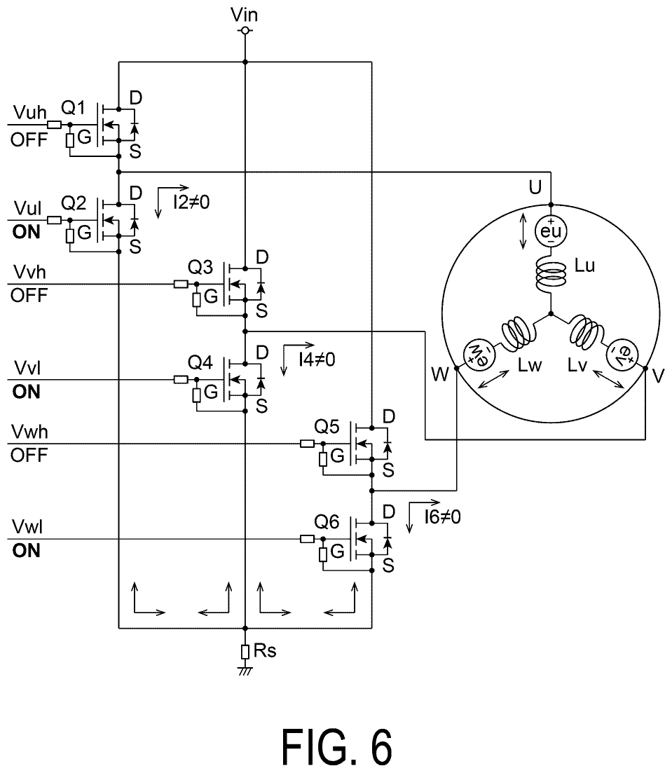

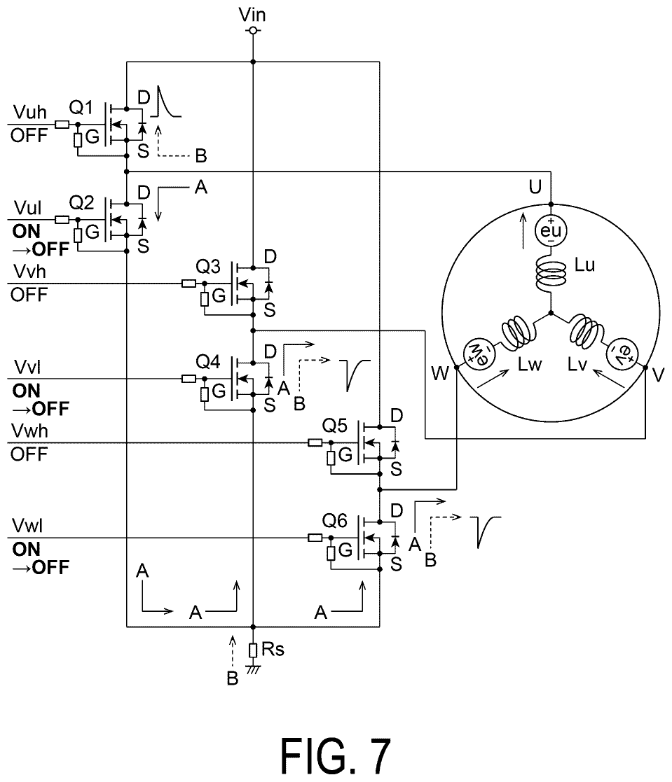

The idling control signal Id is a signal for switching to the corresponding switch state in the order of the free mode (FIG. 5), the charging mode (FIG. 6), and the discharge mode (FIG. 7). More specifically, the idling control signal Id can detect the idling of the rotor of the motor 3 by switching the switch state of the control electrode (gate electrode) of each of the switching elements Q1 to Q6 of the inverter circuit 2a from the first switch state (corresponding to the free mode) illustrated in FIG. 5 to the second switch state (corresponding to the charging mode) illustrated in FIG. 6, and then again to the first switch state (corresponding to the discharge mode) as illustrated in FIG. 7.

### Free Mode

When the idling control signal Id is output from the control circuit 1 by a speed command signal Sc after power-on, the control electrodes (gate electrodes) of the switching elements Q1 to Q6 of the inverter circuit 2a are switched to the first switch state by the idling control signal Id output from the control circuit 1. More specifically, as illustrated in FIG. 5, the switch state of all of the switching elements Q1 to Q6 is switched to off in the inverter circuit 2a.

As illustrated in FIG. 5, in this first switch state, when the rotor of the motor 3 is idling, an induced electromotive force is generated at coils of each phase, while the current that circulates between the coils of the motor 3 and the inverter circuit 2a is not generated due to each of the switching elements Q1 to Q6 being off and the parasitic diode being clamped. In addition, at this time, no current flows through the shunt resistance Rs.

### Charging Mode

Next, the control electrodes (gate electrodes) of the switching elements Q1 to Q6 of the inverter circuit 2a are switched from the first switch state to the second switch state by the idling control signal Id output from the control circuit 1. The second switch state is a switch state where, when the rotor of the motor 3 is idling, an induced electromotive force is generated at coils of each phase, and the generated induced current circulates at the closed circuit composed of the coil and the switching element that is on among the switching elements Q1 to Q6. More specifically, in the inverter circuit 2a, the state is switched from the first switch state where the switch states of all of the switching elements Q1 to Q6 are turned off to the second switch state where only the switch states of the switching elements Q2, Q4 and Q6 of the lower arms of the switching elements Q1 to Q6 are turned on as illustrated in FIG. 6, for example.

As illustrated in FIG. 6, when the second switch state where the switch states of the switching elements Q2, Q4 and Q6 of the lower arms of the switching elements Q1 to Q6 are turned on is set in the inverter circuit 2a, and the rotor of the motor 3 is idling, an induced current circulating between the coils of the motor 3 and the inverter circuit 2a is generated at coils of each phase due to the induced electromotive force, and the generated induced current circulates in the closed circuit composed of the coils and the switching elements Q2, Q4 and Q6 of the lower arms that are turned on. In addition, at this time, no current flows through the shunt resistance Rs because the shunt resistance Rs is not included in the closed circuit.

More specifically, when the rotor of the motor 3 is idling, due to the rotation of the rotor with respect to the coils, induction voltages (eu, ev, ew) proportional to the rotational speed are generated with the polarity in the direction of generation of current hindering a change in the magnetic flux, and with the electrical angle cycle of the rotation of the rotor with each phase shifted by 120 degrees at coils of each phase. At this time, the current waveform has a phase delayed by 90 degrees with respect to the voltage waveform.

### Discharge Mode

Next, the control electrodes (gate electrodes) of the switching elements Q1 to Q6 of the inverter circuit 2a are switched from the second switch state to the first switch state again by the idling control signal Id output from the control circuit 1. More specifically, for example, in the inverter circuit 2a, the state is switched again to the first switch state where the switch states of all of the switching elements Q1 to Q6 are turned off as illustrated in FIG. 7 from the second switch state where the switch states of the switching elements Q2, Q4 and Q6 of the lower arms of the switching elements Q1 to Q6 are turned on.

As illustrated in FIG. 7, when the rotor of the motor 3 is idling, and the state is changed from the second switch state to the first switch state in the inverter circuit 2a, the path of the induced current that has been circulated is blocked. At this time, in the windings (coils) of the motor 3, the induced current (A in FIG. 7) that has been circulated in the coils acts to continuously flow, and as a result an inductive kickback is generated at the inverter circuit 2a. In a short time until voltage variation due to this inductive kickback falls within a voltage range clamped by the parasitic diode of each of the switching elements Q1 to Q6, a voltage rise occurs at the connection point of the upper arm and the lower arm of the leg on the downstream side of the induced current such that a current flows from the coil to the power source side via the parasitic diode of the switching element Q1 of the upper arm, and a voltage drop occurs at the connection point of the upper arm and the lower arm of the leg on the upstream side of the induced current such that a current flows from the ground to the coil via the parasitic diode of the switching elements Q4 and Q6 of the lower arms, and, a current (B in FIG. 7) flows in the inverter circuit direction from the ground of the shunt resistance Rs.

In the motor drive control device 10 of the present embodiment, it is possible to determine that the rotor of the motor 3 is idling when it is detected that a predetermined current has flowed by detecting the kickback current that flows through the shunt resistance Rs due to the inductive kickback generated at the inverter circuit 2a in the discharge mode in the current detection circuit 22.

Note that in the above-mentioned example, an example case where the switch states of the switching elements Q2, Q4 and Q6 of the lower arms of the switching elements Q1 to Q6 of the inverter circuit 2a are turned on as illustrated in FIG. 6 as the second switch state corresponding to the charging mode is described, but this is not limitative.

The second switch state includes a state where the switch states of two of the switching elements Q1, Q3 and Q5 of the upper arms or the switching elements Q2, Q4 and Q6 of the lower arms of the switching elements Q1 to Q6 are turned on. In this switch state, when the rotor of the motor 3 is idling, an induced electromotive force is generated at coils of each phase, and the induced current generated in the closed circuit composed of the transistor turned on among the switching elements Q1 to Q6 and the coil circulates. Specifically, the second switch state can be said to be a switch state where, when the rotor of the motor 3 is idling, an induced electromotive force is generated at coils of each phase, and the induced current generated in the closed circuit composed of the transistor turned on among the switching elements Q1 to Q6 and the coils circulates.

On the other hand, the case where the switch state of any one of the switching elements Q1, Q3 and Q5 of the upper arms or the switching elements Q2, Q4 and Q6 of the lower arms of the switching elements Q1 to Q6 is turned on is not included in the second switch state because there is no closed circuit at all times and as a result the induced current does not circulate at all times.

Referring to FIG. 1 again, the current detection circuit 22 is a circuit for detecting the energization current flowing through the coils of three phases Lu, Lv, and Lw of the motor 3 and flowing through the shunt resistance Rs in the ground direction by controlling the inverter circuit 2a in the motor drive and the rotor initial position detection, and to detect the kickback current flowing in the inverter circuit direction of the inverter circuit 2a from the ground in the shunt resistance Rs by the inductive kickback in the rotor initial position detection and the rotor idling detection. The current detection circuit 22 outputs to the control circuit 1 the current detection signal Vs corresponding to the current flowing through the shunt resistance Rs.

In the motor drive, the control circuit 1 controls the drive of the motor 3 by generating the drive control signal Sd for driving the motor 3 on the basis of the externally input speed command signal Sc that instructs the target state of the operation of the motor 3, for example. More specifically, the control circuit 1 generates the drive control signal Sd such that the motor 3 is set to the operation state designated by the speed command signal Sc, and provides it to the driving circuit 2.

In the rotor initial position detection, the control circuit 1 generates the initial position detection signal Pd instead of the drive control signal Sd to detect the initial position of the rotor. More specifically, the control circuit 1 generates the initial position detection signal Pd such that each of the switching elements Q1 to Q6 of the inverter circuit 2a is set to the switch state designated by the initial position detection signal Pd, and provides the signal to the driving circuit 2.

Further, in the rotor idling detection in the rotor stoppage waiting, the control circuit 1 generates the idling control signal Id instead of the drive control signal Sd to detect the idling of the rotor of the motor 3. More specifically, the control circuit 1 generates the idling control signal Id such that each of the switching elements Q1 to Q6 of the inverter circuit 2a is set to the switch state designated by the idling control signal Id, and provides the signal to the driving circuit 2.

In the above-mentioned embodiment, the control circuit 1 is a program processing device (for example micro controller) with a configuration with a processor such as a CPU, various storage devices such as a RAM and a ROM, a counter (timer), an A/D conversion circuit, a D/A conversion circuit, a clock generation circuit, and a peripheral circuit such as an input/output I/F circuit connected to each other through a bus or a dedicated line, for example.

Note that the motor drive control device 10 may have a configuration with at least a part of the control circuit 1 and at least a part of the driving circuit 2 packaged as one integrated circuit device (IC), or a configuration with the control circuit 1 and the driving circuit 2 packaged as individual respective integrated circuit devices.

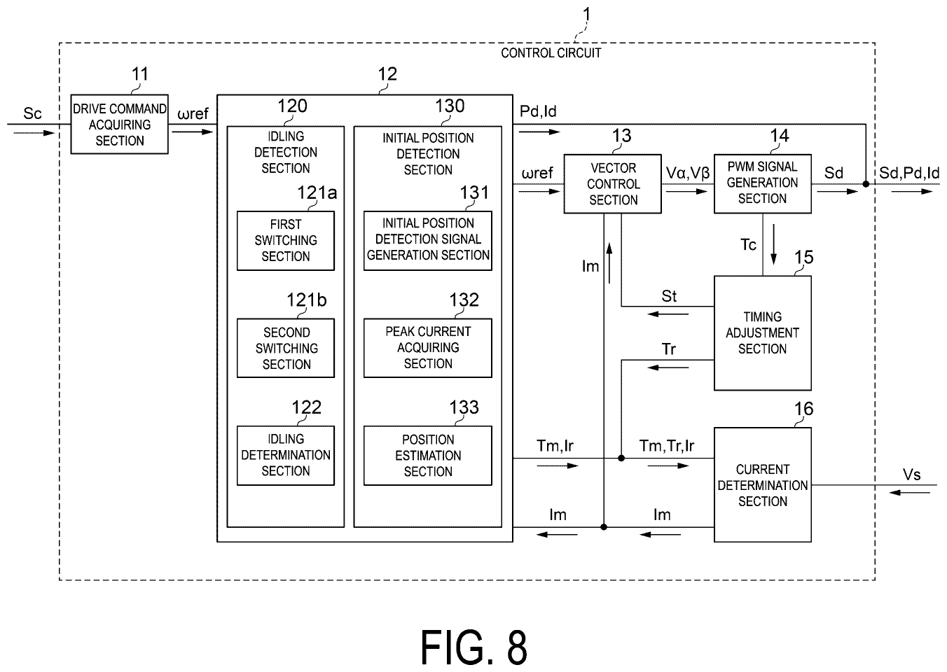

FIG. 8 is a diagram illustrating a functional block configuration in the control circuit 1 of the motor drive control device 10 according to the embodiment.

As illustrated in FIG. 8, the control circuit 1 includes a drive command acquiring section 11, a state control section 12, a vector control section 13, a PWM signal generation section 14, a timing adjustment section 15 and the current measurement section 16, as a functional blocks for generating the drive control signal Sd in motor drive by vector control, for example. The control circuit 1 includes an initial position detection section 130 and the current measurement section 16, as functional blocks for generating the initial position detection signal Pd in the rotor initial position detection. The initial position detection section 130 includes an initial position detection signal generation section 131, a peak current acquiring section 132 and a position estimation section 133. In addition, the control circuit 1 includes an idling detection section 120 and the current measurement section 16, as functional blocks for generating the idling control signal Id in the rotor idling detection. The idling detection section 120 includes a first switching section 121a, a second switching section 121b, and an idling determination section 122.

These functional blocks are implemented when the processor executes various arithmetic processing in accordance with the programs stored in the memory and controls the peripheral circuit such as the counter and the A/D conversion circuit in the program processing device serving as the control circuit 1, for example.

By receiving the speed command signal Sc from the outside and analyzing the received speed command signal Sc, the drive command acquiring section 11 acquires a value for designating the target operation state of the motor 3 designated by the speed command signal Sc.

The speed command signal Sc includes a value that instructs the operation target state of the motor 3. The speed command signal Sc is a signal that is output from a higher-level device for controlling the motor unit 100 provided outside the motor drive control device 10, for example.

In the above-mentioned embodiment, the speed command signal Sc designates the rotational speed of the rotor of the motor 3, for example. The speed command signal Sc includes a value ωref of the rotational speed (target rotational frequency) serving as a target of the rotor of the motor 3.

The speed command signal Sc is a PWM signal with a duty ratio corresponding to the designated target rotational speed ωref, for example. The drive command acquiring section 11 measures the duty ratio of the PWM signal of the speed command signal Sc, and outputs the rotational speed corresponding to the measured duty ratio as the target rotational speed ωref, for example.

The state control section 12 outputs the target rotational speed ωref as is to the vector control section 13 in the motor drive. The state control section 12 inputs to the vector control section 13 the initial position of the rotor detected at the initial position detection section 130 described later, and the vector control section 13 can use the position as the rotor starting position in the motor 3. In this manner, a smooth motor start with small consumption current, vibration and noise can be achieved. When the idling determination signal described later is generated from the idling determination section 122, the state control section 12 can determine which of windmill start or forced-flow start is used as the motor starting method. Note that although not specifically illustrated in FIG. 8, the vector control section 13 and the state control section 12 may further include a functional part for executing the above-described processes.

Further, the state control section 12 generates a measurement trigger signal Tm and an idling trigger signal Ir in the rotor initial position detection and the rotor idling detection, and generates a current measurement value Im from the current detection signal Vs detected at the current detection circuit 22. More specifically, the state control section 12 generates at a predetermined timing the measurement trigger signal Tm and the idling trigger signal Ir for switching on a sampling circuit 51 of the current measurement section 16 described later, and provides the signals to the current measurement section 16. Note that although not specifically illustrated in FIG. 8, the state control section 12 may further include a functional part that executes the process of generating the measurement trigger signal Tm and the idling trigger signal Ir.

In the motor drive, the vector control section 13 generates voltage values Vα and Vβ from the target rotational speed ωref and the current measurement value Im in accordance with known vector control, and outputs the values to the PWM signal generation section 14 (space vector modulation: SVM). At this time, the current measurement value Im is subjected to offset adjustment described later, and handled as winding current measurement values Iu, Iv and Iw by the measurement timing of the drive control signal Sd and a timing signal St generated at the timing adjustment section 15 described later.

In the motor drive, the PWM signal generation section 14 outputs the drive control signal Sd to the driving circuit 2 to PWM-control the driving circuit 2, and outputs to the timing adjustment section 15 a PWM count signal Tc, the PWM count signal Tc being a signal indicating the count start of each PWM cycle in the PWM control.

In the motor drive, the timing adjustment section 15 starts the timing generation counter in synchronization with the count start of each PWM cycle, and triggers the current measurement section 16 to measure the current due to energization during the drive. More specifically, the timing adjustment section 15 outputs a drive trigger signal Tr to the current measurement section 16 at the current capture timing synchronized with the energization based on the PWM count signal Tc output from the PWM signal generation section 14.

In the motor drive, the current measurement section 16 performs A/D conversion on the current detection signal Vs corresponding to the winding currents Iu, Iv, and Iw on the basis of the drive trigger signal Tr or the measurement trigger signal Tm, and further performs the offset adjustment described later to generate the current measurement value Im. The current measurement value Im is output to the vector control section 13, and the vector control section 13 performs the vector control from the current values of three phases on the basis of the timing signal St from the timing adjustment section 15, and calculates the magnitude of the energization at the PWM signal generation section 14.

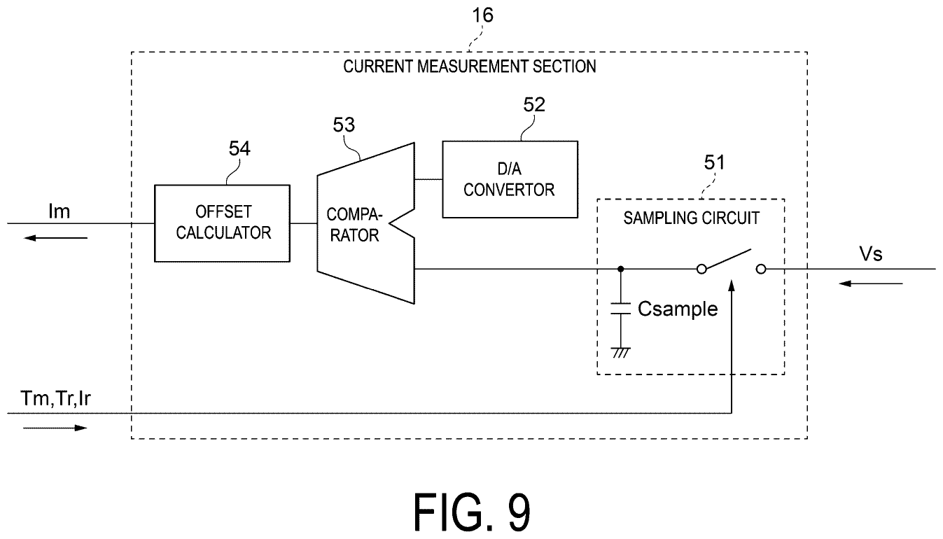

FIG. 9 is a diagram illustrating an example of a configuration of the current measurement section 16 included in the control circuit 1 of the motor drive control device 10. The current measurement section 16 includes the sampling circuit 51, a D/A convertor 52, a comparator 53, and an offset calculator 54.

The current measurement section 16 in FIG. 9 performs at a predetermined timing A/D conversion on the current detection signal Vs corresponding to the current flowing through the shunt resistance Rs input from the current detection circuit 22, and further performs the offset adjustment described later, and, generates the current measurement value Im to be used at the control circuit 1. The current measurement value Im is a value corresponding to the current that flows through the shunt resistance Rs of the current detection circuit 22.

More specifically, the sampling circuit 51 in FIG. 9 is composed of a switch and a capacitor, and is switched on/off in accordance with the drive trigger signal Tr, the measurement trigger signal Tm, or the idling trigger signal Ir output from the timing adjustment section 15 or the state control section 12 of the control circuit 1 so as to perform A/D conversion on the current detection signal Vs, the current detection signal Vs being the output voltage of the current detection circuit 22, at a predetermined timing, for example. The A/D conversion is performed through sampling of the sample period of the sampling circuit 51, and quantization of the hold period by the D/A convertor 52 and the comparator 53. The value generated through the A/D conversion is further subjected to the offset adjustment described later by the offset calculator 54, and thus the current measurement value Im corresponding to the current flowing through the shunt resistance Rs is generated. In the motor drive, the current measurement value Im is used at the vector control section 13 as the winding current measurement values Iu, Iv and Iw. In addition, in the rotor initial position detection, the current measurement value Im is used at the peak current acquiring section 132 of the state control section 12 described later of the control circuit 1. Further, in the rotor idling detection, the current measurement value Im is used at the idling determination section 122 of the state control section 12 described later of the control circuit 1.

Now, the offset adjustment is described. Since the current detection circuit 22 can measure the current flowing in both directions at the shunt resistance Rs, the voltage drop signal Vout at the shunt resistance Rs and the current detection signal Vs smoothened at the delay circuit 31 are offset by a direct current power source Vdc/2 at the bidirectional current detection circuit 30 of the current detection circuit 22. As a result, in the current measurement section 16, the current measurement value Im is set to a value other than zero in the state where no current flows through the shunt resistance Rs. When the current measurement value Im in the state where no current flows through the shunt resistance Rs is set to zero through the offset adjustment, the same current measurement as the current measurement of the known ground direction (from the inverter circuit 2a toward the ground direction) is achieved, and further the current direction is clarified with positive and negative signs.

For the offset adjustment, the state control section 12 performs A/D conversion on the current detection signal Vs input to the current measurement section 16 in the free mode or the charging mode as the state where no current flows through the shunt resistance Rs to acquire offset values in advance, and uses the acquired offset values at the offset calculator 54 of the current measurement section 16.

More specifically, in the free mode (the initial first switch state) or the charging mode (the second switch state), the state control section 12 outputs the idling trigger signal Ir for switching on the sampling circuit 51 of the current measurement section 16, performs A/D conversion on the current detection signal Vs input from the current detection circuit 22, and specifies as an offset value the current measurement value generated by deactivating the offset calculator 54. The generation of current measurement values through deactivation of the offset calculator 54 may be repeated multiple times to set the average value of the current measurement values generated multiple times as the offset value. In the free mode or the charging mode, no current flows through the shunt resistance Rs of the current detection circuit 22 regardless of the presence/absence of the idling state of the rotor of the motor 3, and therefore the current detection signal Vs detected at this time can be used as the reference of the current zero, and can be set as the offset used in generation of the current measurement value Im.

The offset adjustment may be performed immediately after power-on, or in the free mode immediately after the input of the speed command signal Sc, or, in the charging mode after the input of the speed command signal Sc.

In the rotor idling detection, in the discharge mode, i.e., when the state is switched from the second switch state to the first switch state, the state control section 12 outputs to the current measurement section 16, the idling trigger signal Ir for switching on the sampling circuit 51 at a predetermined timing to instruct measurement of the input current detection signal Vs, and generates the current measurement value Im by performing A/D conversion on the input current detection signal Vs and further performing the offset adjustment. The current measurement section 16 outputs the generated current measurement value Im to the idling determination section 122 of the state control section 12.

The idling determination section 122 determines whether the rotor of the motor 3 is idling on the basis of the current measurement value Im generated at the current measurement section 16, and generates an idling determination signal representing the determination result of idling. More specifically, the idling determination section 122 compares the idling threshold value set in advance and the current measurement value Im generated by the current measurement section 16, and determines that the rotor of the motor 3 is idling when the maximum current measurement value Im on the minus side that is the inverter circuit direction side is smaller than the idling threshold value (the negative value is large).

When the rotor of the motor 3 is idling, the inductive kickback is generated at a timing of switching to the discharge mode, and a current flows in the inverter circuit direction from the ground toward the inverter circuit 2a. When the rotor of the motor 3 is idling at a high speed, the induced electromotive force increases in accordance with the rotational speed and the induced current in the charging mode increases, thus resulting in an increase in the duration of the inductive kickback and an increase in the kickback current flowing through the shunt resistance Rs in the inverter circuit direction, and this phenomenon is used for the determination. The idling determination section 122 can employ, as the idling threshold value, the value in a range from the current measurement value (small negative value) of the current flowing through the shunt resistance Rs due to the inductive kickback when the rotor of the motor 3 is stopped, to the current measurement value (large negative value) corresponding to the current flowing through the shunt resistance Rs due to the inductive kickback when the minimum rotational speed is idling, for example.

In the state control section 12, the idling detection section 120 includes the first switching section 121a, the second switching section 121b, and the idling determination section 122. The first switching section 121a and the second switching section 121b are functional blocks for generating the idling control signal Id in the rotor idling detection. The idling determination section 122 is a functional block for performing the rotor idling determination.

In the idling detection section 120, the first switching section 121a generates a first idling control signal Id1 for switching the switching elements Q1 to Q6 making up the inverter circuit 2a to the first switch state. In the idling detection section 120, the second switching section 121b generates a second idling control signal Id2 for switching the switching elements Q1 to Q6 making up the inverter circuit 2a to the second switch state. The first and second idling control signals Id1 and Id2 (in the specification, simply referred to as “the idling control signals Id”) generated by the first switching section 121a and the second switching section 121b of the idling detection section 120 are output to the driving circuit 2.

To set the switch state that enables the rotor idling detection, the idling detection section 120 generates the first idling control signal Id1 corresponding to the free mode at the first switching section 121a until the speed command signal Sc is received at the drive command acquiring section 11 after power-on. Thereafter, in the charging time (the period corresponding to the charging mode), the idling detection section 120 generates the second idling control signal Id2 with the second switching section 121b. Thereafter, in the discharge time (the period corresponding to the discharge mode), the idling detection section 120 generates the first idling control signal Id1 with the first switching section 121a again. Note that after the discharge time, the first idling control signal Id1 corresponding to the free mode may be generated with the first switching section 121a.

The shift timing from the free mode to the charging mode may be after the drive command acquiring section 11 has received the speed command signal Sc, for example.

The charging time can be set to 10 times the time constant that is defined from the inductance and the coil winding resistance of the motor 3. The coils of the motor 3 can be considered as an RL series circuit because winding resistance and inductance are provided, and the time taken for the winding current to be stabilized is 10 times the time constant. For example, when the winding resistance is 0.44Ω and the inductance is 0.4333 m H, the time constant is 1 ms. In this case, the charging time may be 10 ms. The longer the charging time, the clearer the determination of the idling and stoppage of the rotor at a low rotational speed; however, the charging time is preferably short because the inverter circuit is in the short break state, and therefore the period of the rotor idling detection process is shortened.

In the discharge time, the kickback current flowing in the inverter circuit direction at the shunt resistance Rs due to the inductive kickback is attenuated and converges to zero, and therefore the discharge time need only be a time equal to or greater than the time constant of the delay circuit 31 in the current detection circuit 22. At this time, when the maximum current in the inverter circuit direction can be measured, the presence/absence of the idling state of the rotor of the motor 3 can be determined, and as such it is possible to determine that the discharge time may be reached when the measured current in the inverter circuit direction is reduced. In addition, the discharge time may be set to a time equal to or greater than 0.5 times the time constant that is defined from the inductance and the coil winding resistance of the motor 3. The reason for this is that while 0.5 times the time constant is a timing when the kickback current flowing in the inverter circuit direction at the shunt resistance Rs attenuates and converges to about 60% of the peak time due to decay, it suffices that the maximum current in the inverter circuit direction at the shunt resistance Rs can be detected in the discharge mode. For example, when the winding resistance is 0.44Ω and the inductance is 0.4333 m H, the time constant is 1 ms. In this case, the discharge time is 0.5 ms.

In the state control section 12, the initial position detection section 130 includes the initial position detection signal generation section 131, the peak current acquiring section 132 and the position estimation section 133.

The initial position detection signal generation section 131 generates the initial position detection signal Pd for performing energization and interruption in the energization direction of the coil corresponding to the energization sector by turning on/off the high-side switches Q1, Q3, and Q5 and the low-side switches Q2, Q4, and Q6 of the inverter circuit 2a in such a manner as to sequentially switch the energization sector without rotating the rotor of the motor 3. Details of the initial position detection signal Pd are described later.

On the basis of the current detected at the bidirectional current detection circuit 30 when the initial position detection signal Pd is generated, the peak current acquiring section 132 acquires, for each energization sector, the peak value of the energization current that flows in the ground direction during energization, and the peak value of the kickback current due to the inductive kickback that flows in the inverter circuit direction upon interruption of energization. In conjunction with a functional part that executes the process of generating the measurement trigger signal Tm, the peak current acquiring section 132 acquires, as the peak value of the kickback current and the peak value of the energization current for each energization sector, the current measurement value Im measured at the current measurement section 16 in accordance with the measurement trigger signal Tm generated at a timing defined by the initial position detection signal Pd. Details of the timing are described later.

The position estimation section 133 estimates the position of the rotor on the basis of the peak value of the kickback current and the peak value of the energization current for each energization sector. More specifically, the position estimation section 133 compares the total current value of the peak value of the kickback current and the peak value of the energization current for each energization sector, and estimates that the position of the rotor is located at the position corresponding to the energization sector with the largest total current value.

With the above-mentioned estimation method at the position estimation section 133, in some situations it is difficult to determine the largest total current value because of slight differences among total current values obtained through the comparison of the total current value of the peak value of the kickback current and the peak value of the energization current for each energization sector. In this case, the position estimation section 133 may estimate the position of the rotor by the same method again, but may specify the energization sector corresponding to the initial position of the rotor by sequentially or independently executing the following two methods as estimation methods added to the above-mentioned estimation.

As the first method of the additional estimation method, the position estimation section 133 acquires the energization sector with the maximum magnitude of the peak value of the energization current flowing in the ground direction and an energization sector with the maximum magnitude of the peak value of the kickback current due to the inductive kickback flowing in the inverter circuit direction. The position estimation section 133 performs estimation as follows in accordance with the number of the acquired energization sectors.

(1) When there is one energization sector with the maximum peak value of the energization current flowing in the ground direction, and there is one energization sector with the maximum peak value of the kickback current due to the inductive kickback flowing in the inverter circuit direction, and, they are the same energization sector, it is estimated that the position of the rotor is located at a position corresponding to the same one energization sector.

(2) When there is one energization sector with the maximum peak value of the energization current flowing in the ground direction, and there is one energization sector with the maximum peak value of the kickback current due to the inductive kickback flowing in the inverter circuit direction, and, they are different energization sectors, the rotor initial position detection process is executed again.

(3) When there is one energization sector with the maximum peak value of the energization current flowing in the ground direction, and there are a plurality of energization sectors with the maximum peak value of the kickback current due to the inductive kickback flowing in the inverter circuit direction, including the one energization sector with the maximum peak value of the energization current, it is estimated that the position of the rotor is located at a position corresponding to the one energization sector with the maximum peak value of the energization current.

(4) When there is one energization sector with the maximum peak value of the energization current flowing in the ground direction, and there are a plurality of energization sectors with the maximum peak value of the kickback current due to the inductive kickback flowing in the inverter circuit direction, not including the one energization sector with the maximum peak value of the energization current, the rotor initial position detection process is executed again.

(5) When there are a plurality of energization sectors with the maximum peak value of the energization current flowing in the ground direction, and there are a plurality of energization sectors with the maximum peak value of the kickback current due to the inductive kickback flowing in the inverter circuit direction, including a common energization sector, it is estimated that the position of the rotor is located at a position corresponding to the common energization sector.

(6) When there are a plurality of energization sectors with the maximum peak value of the energization current flowing in the ground direction, and there are a plurality of energization sectors with the maximum peak value of the kickback current due to the inductive kickback flowing in the inverter circuit direction, not including a common energization sector, the rotor initial position detection process is executed again.

As the second method of the additional estimation method, the position estimation section 133 further acquires the differences in current between three bidirectional energizations from the “total current value” of each energization sector by using the total current value, the total current value being the sum of the magnitude of the peak value of the energization current flowing in the ground direction and the magnitude of the peak value of the kickback current due to the inductive kickback flowing in the inverter circuit direction, for each energization sector. When there is one maximum value of the differences in current between three bidirectional energizations, it is estimated that the position of the rotor is located at a position corresponding to the energization sector with a larger “total current value” among two energization sectors with the maximum value of the bidirectional energization. More specifically, the three bidirectional energizations are three combinations with the current vectors at 180 degrees, namely, the combination of the energization sector 4 and the energization sector 3, the combination of the energization sector 2 and the energization sector 5, and the combination of the energization sector 1 and the energization sector 6. In this case, for example, the difference dIu in current between the bidirectional energizations of the energization sector 4 and the energization sector 3 is the difference between the total current value of the energization sector 4 and the total current value of the energization sector 3. The differences dIu, dIv and dIw in current between three bidirectional energizations are acquired by calculating the other bidirectional energizations in the same manner. Subsequently, the largest difference in current between the bidirectional energizations among the differences in current between three bidirectional energizations is specified, and it is estimated that the position of the rotor is located at a position corresponding to the energization sector with a larger “total current value” among the two energization sectors of the specified bidirectional energization. For example, when dIu is the largest value among the differences in current between three bidirectional energizations, it is estimated that the position of the rotor is located at a position corresponding to the energization sector with a larger “total current value” among the energization sector 4 and the energization sector 3. In addition, when there are two maximum values of the differences in current between three bidirectional energizations and the “total current values” of the four energization sectors of the bidirectional energizations are different from each other, it is possible to estimate that the position of the rotor is located at a position corresponding to the energization sector with the largest “total current value”.

Next, the following describes a mode shift when executing the rotor idling detection at the idling detection section 120 in order to confirm the stoppage of the rotor of the motor 3 after power-on. In the state control section 12, after confirming that the rotor is not idling as a result of the rotor idling detection at the idling detection section 120 (rotor stoppage waiting), the rotor initial position detection is executed by the initial position detection section 130.

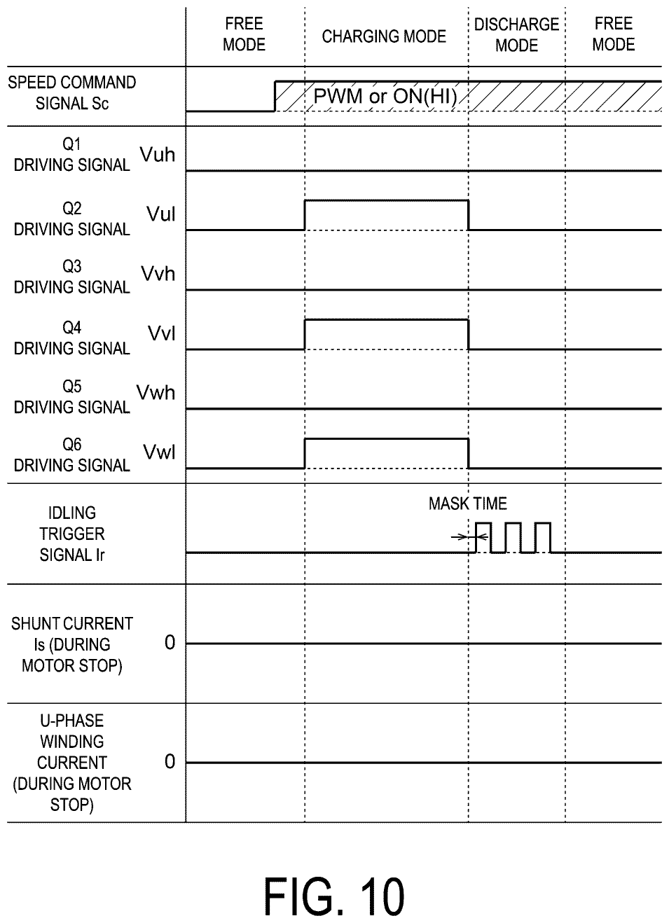

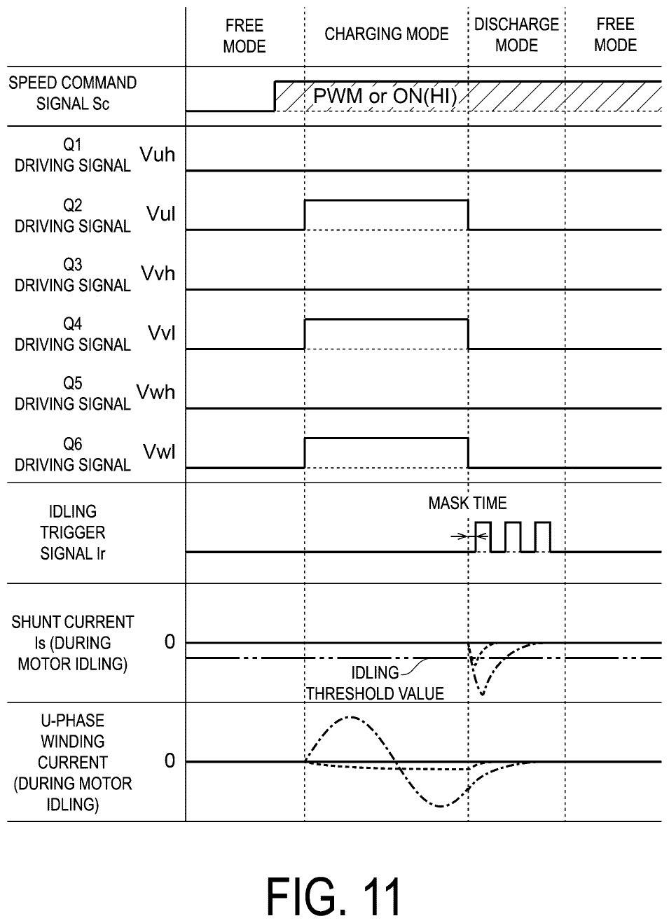

FIGS. 10 and 11 are timing diagrams illustrating an example of a signal waveform from input of the speed command signal Sc after power-on of the motor unit 100 to completion of the rotor idling detection. FIG. 10 is a timing diagram of a case where the rotor of the motor 3 is not moving at all, and FIG. 11 is a timing diagram of a case where the rotor of the motor 3 is moving (idling).

FIGS. 10 and 11 illustrate, from the upper side, waveforms of the speed command signal Sc, driving signals input to the gates of the switching elements Q1 to Q6, the idling trigger signal Ir for controlling the switch of the sampling circuit 51 at the current measurement section 16, the shunt current Is detected at the shunt resistance Rs of the current detection circuit 22, and the U-phase winding current. Note that the shunt current Is is a current flowing through the shunt resistance Rs of the current detection circuit 22, and is a current corresponding to the current detection signal Vs.

As illustrated in FIGS. 10 and 11, the motor drive control device 10 is set to the free mode, the charging mode, the discharge mode, and then returned to the free mode again. At this time, the motor drive control device 10 starts from the free mode after power-on. Note that the mode is set to the free mode again after the discharge mode in the timing diagrams illustrated in FIGS. 10 and 11 as an example, but this is not limitative.

In the free mode, the inverter circuit 2a is set to the first switch state by the first idling control signal Id1 generated by the first switching section 121a. More specifically, all of the driving signals input to the gates of the switching elements Q1 to Q6 making up the inverter circuit 2a are set to the low level by the first idling control signal Id1, and thus all switches of the inverter circuit 2a are turned off. In this state, the closed circuit is not formed between the coils of the motor 3 and the inverter circuit 2a regardless of the presence/absence of the idling state of the rotor of the motor 3, and thus the current of the coils of the motor 3 becomes zero. In addition, no current flows through the shunt resistance Rs.

In addition, in the examples in FIGS. 10 and 11, in the free mode, the idling trigger signal Ir for measuring the shunt current Is is at the low level. However, in this period, the idling trigger signal Ir may be set to the high level at a predetermined timing. In this case, the current measurement section 16 may acquire the current detection signal Vs output from the current detection circuit 22, as the offset because no current flows through the shunt resistance Rs.

Next, in the charging mode, the inverter circuit 2a is set to the second switch state by the second idling control signal Id2 generated by the second switching section 121b. More specifically, the driving signals input to the gates of the switching elements Q2, Q4 and Q6 of the lower arms of the switching elements Q1 to Q6 making up the inverter circuit 2a are set to the high level by the second idling control signal Id2, thus turning on all of the low-side switches of the inverter circuit 2a.

In this state, when the rotor of the motor 3 is not moving at all, no current flows through the coils of the motor 3 and the shunt resistance Rs as in the free mode as illustrated in FIG. 10. On the other hand, when the rotor of the motor 3 is moving, an induced electromotive force is generated at the coils of the motor 3, and a closed circuit is formed by the coils of the motor 3 and the switching elements Q2, Q4, and Q6 turned on at the inverter circuit 2a as illustrated in FIG. 11 such that a current circulating between the coils of the motor 3 and the inverter circuit 2a is generated and that an induced current corresponding to the rotational speed of the rotor of the motor 3 flows through the coils, while at this time, no current flows through the shunt resistance Rs because the shunt resistance Rs is not included in the closed circuit.

In addition, in the examples in FIGS. 10 and 11, in the charging mode, the idling trigger signal Ir for measuring the shunt current Is is at the low level. However, in this period, the high level may be set at a predetermined timing. In this case, the current measurement section 16 can acquire the current detection signal Vs output from the current detection circuit 22, as the offset because no current flows through the shunt resistance Rs. Note that in the case where the offset is acquired in the free mode, the offset may not be acquired at this timing again.

Next, in the discharge mode, the inverter circuit 2a is set to the first switch state again by the first idling control signal Id1 generated by the first switching section 121a. More specifically, all of the driving signals input to the gates of the switching elements Q1 to Q6 making up the inverter circuit 2a are set to the low level again by the first idling control signal Id1, and thus all switches of the inverter circuit 2a are turned off.

In this state, when the rotor of the motor 3 is moving (idling), the current circulating between the coils of the motor 3 and the inverter circuit 2a acts to continue to flow through the coils in this period, and thus the inductive kickback is generated in the inverter circuit due to turning off of all switching elements. Due to this inductive kickback, in the shunt resistance Rs, the current that increases the inverter circuit direction from the ground toward the inverter circuit 2a is momentarily generated, and converges to zero. At this time, idling of the rotor of the motor 3 can be determined in a short time although the rotational direction of the rotor of the motor 3 cannot be determined, by detecting the current that flows through the shunt resistance Rs with the current detection circuit 22, and measuring the maximum current in the inverter circuit direction through continuous measurement with the current measurement section 16.

In addition, in the discharge mode, when the current mask time elapses a predetermined mask time, the idling trigger signal Ir for measuring the shunt current Is becomes the high level at a predetermined timing. The predetermined mask time is set as a period for removing electromagnetic noise due to switching of the inverter circuit 2a due to switching of the driving signal. When the current mask time elapses the predetermined mask time, the current measurement section 16 acquires the current detection signal Vs output from the current detection circuit 22, and measures the current that flows through the shunt resistance Rs.

FIG. 11 illustrates the shunt current Is and the U-phase winding current in two states. When the rotational speed of the idling of the rotor is low, in the charging mode, the period of the U-phase winding current (dotted line) is long with a small amplitude, and a small shunt current (dotted line) is generated to the minus side that is the inverter circuit direction side due to the inductive kickback of the discharge mode, and, the kickback current flowing in the inverter circuit direction of the shunt resistance Rs is small. On the other hand, when the rotational speed of the idling of the rotor is high, in the charging mode, the period of U-phase winding current (dashed line) is short with a large amplitude, and a large shunt current (dashed line) is generated to the minus side due to the inductive kickback of the discharge mode, and, the kickback current flowing in the inverter circuit direction of the shunt resistance Rs is large. In both cases, the maximum current of the shunt current Is in the inverter circuit direction observed at the idling determination section 122 is smaller (the negative value is large) than the idling threshold value (chain double-dashed line) for determining the idling of the rotor, and therefore it is determined that the rotor of the motor 3 is idling. When the idling is determined, a stoppage of the rotor may be confirmed by periodically repeating the rotor idling detection. At this time, the inverter circuit may be periodically set to the short circuit break state to reduce the time until the stoppage of the rotor.

Next, the following describes energization/interruption for each energization sector in the case where the rotor initial position detection is executed by the initial position detection section 130 from the state where the rotor is stopped (not idling).

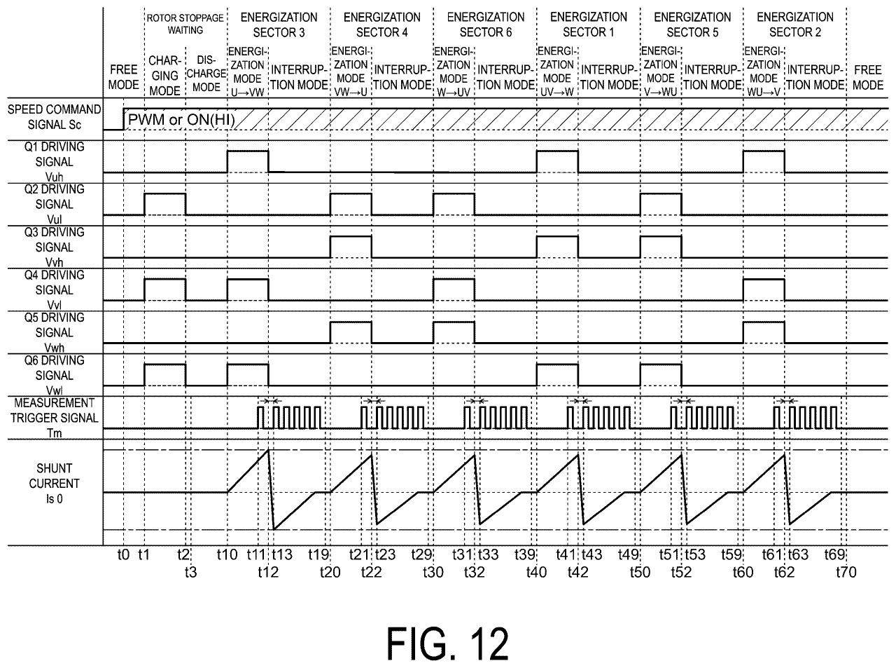

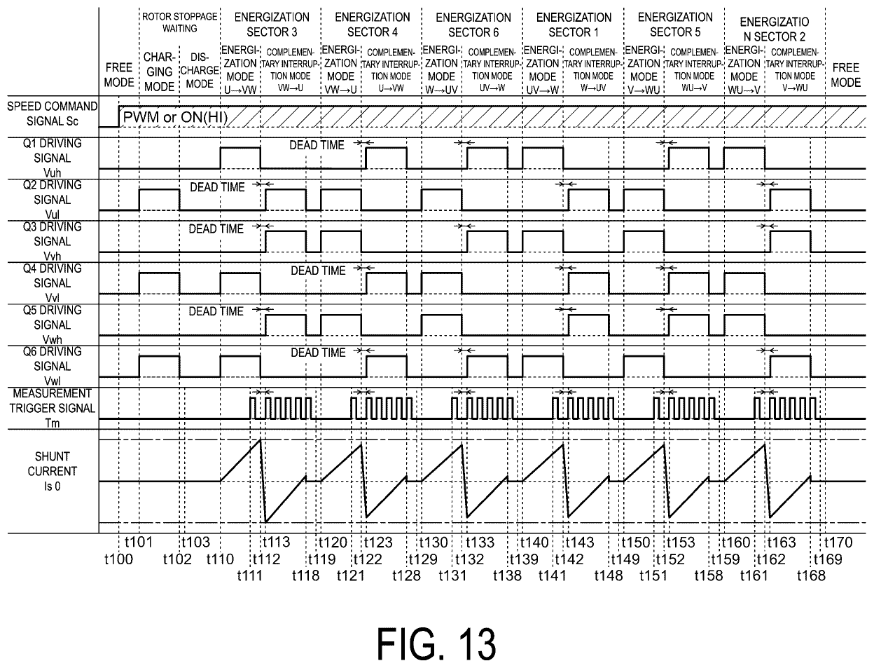

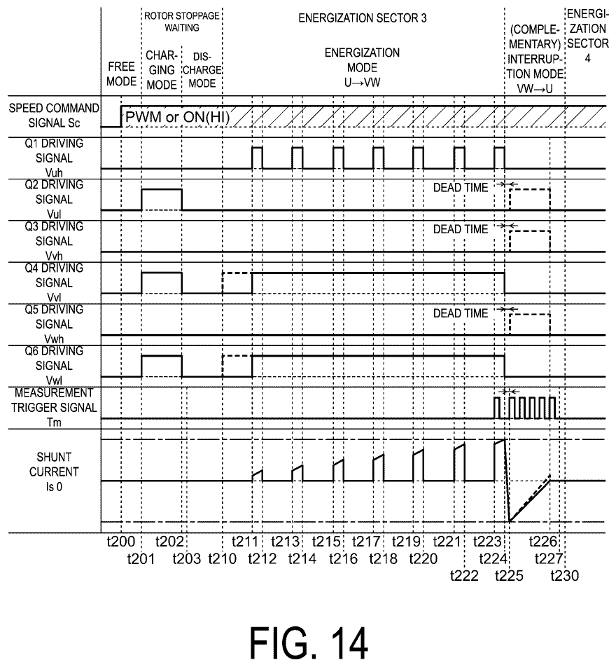

FIGS. 12 and 13 are timing diagrams illustrating examples of a signal waveform in the case where the speed command signal Sc is input after power-on of the motor unit 100, and then a stoppage of the rotor is confirmed, and thereafter, the rotor initial position detection is completed. FIG. 14 is another timing diagram illustrating an example of a signal waveform of energization/interruption for one energization sector in the rotor initial position detection in the case where the speed command signal Sc is input after power-on of the motor unit 100, and then a stoppage of the rotor confirmed. In the present embodiment, a case where the energization system is a 1-2-phase excitation system is described as an example.

FIGS. 12 to 14 illustrate from the upper side, the speed command signal Sc, driving signals input to the gates of the switching elements Q1 to Q6, the measurement trigger signal Tm that controls the switch of the sampling circuit 51 in the current measurement section 16, and the shunt current Is detected at the shunt resistance Rs of the current detection circuit 22. Note that the shunt current Is is a current flowing through the shunt resistance Rs of the current detection circuit 22, and is a current corresponding to the current detection signal Vs. The idling trigger signal Ir and the shunt current Is in the rotor idling detection until the rotor stoppage waiting are omitted here because they are described in FIGS. 10 and 11.

The systems for energization/interruption for each energization sector include [1: Normal System], [2: Complementary Block System], and [3: Low-Noise System], and each system is described separately below. FIG. 12 is a timing diagram of a normal system, FIG. 13 is a timing diagram of a complementary block system, and FIG. 14 is a timing diagram of a low-noise system.

### 1: Normal System

As illustrated in FIG. 12, in a normal system, the mode is set to the energization mode and the interruption mode, and then returned to the free mode while the motor drive control device 10 switches the energization sector. Note that the timing diagram in FIG. 12 illustrates an example case where the free mode is set after the last interruption mode, but this is not limitative.

First, energization is performed in the energization mode for the energization sector 3. In the energization sector 3, as illustrated in FIG. 3, energization is performed to flow from the U-phase to the V-phase and the W-phase. More specifically, during the predetermined magnetic saturation time (t10 to t12), the initial position detection signal generation section 131 generates the initial position detection signal Pd for turning on the switching elements Q1, Q4, and Q6, and the peak current acquiring section 132 outputs to the current measurement section 16 a pulse of the measurement trigger signal Tm at timing (t11) slightly before the current energization time elapses the predetermined magnetic saturation time in consideration of the sampling time of the A/D conversion at the current measurement section 16. In this manner, the peak value of the shunt current Is (energization current) flowing in the ground direction at the shunt resistance Rs during energization in the energization sector 3 can be acquired.

When the current energization time elapses the predetermined magnetic saturation time, the initial position detection signal generation section 131 shifts to the interruption mode, and generates the initial position detection signal Pd for changing the switching elements Q1, Q4, and Q6 from on to off, whereas when the current mask time elapses the predetermined mask time (t13) from timing (t12) of turning off of the switching elements Q1, Q4, and Q6, the peak current acquiring section 132 starts the output of the pulse of the measurement trigger signal Tm to the current measurement section 16. When it is confirmed that the shunt current Is has converged to substantially zero, the peak current acquiring section 132 stops the output of the pulse of the measurement trigger signal Tm (t19). In this manner, during interruption at the energization sector 3, the peak value of the shunt current Is flowing in the inverter circuit direction at the shunt resistance Rs (kickback current) can be acquired, and the fact that the shunt current Is has returned to zero again can be determined. When it is confirmed that the shunt current Is has converged to substantially zero, the peak current acquiring section 132 notifies the initial position detection signal generation section 131 of that fact. By receiving this notification, the initial position detection signal generation section 131 can confirm that the magnitude of the kickback current has converged to zero. By using the fact that the shunt current has converged to zero, the next current measurement can be made accurate, and the measurement time for each one energization sector can be reduced.

Next, energization is performed in the energization mode for the energization sector 4. In the energization sector 4, as illustrated in FIG. 3, energization is performed to flow from the V-phase and the W-phase to the U-phase. More specifically, after it is confirmed that the magnitude of the kickback current has converged to zero (t19), the initial position detection signal generation section 131 generates the initial position detection signal Pd for turning on the switching elements Q2, Q3, and Q5 during the predetermined magnetic saturation time (t20 to t22), and the peak current acquiring section 132 outputs to the current measurement section 16 a pulse of the measurement trigger signal Tm at timing (t21) slightly before the current energization time elapses the predetermined magnetic saturation time in consideration of the sampling time of the A/D conversion at the current measurement section 16. In this manner, the peak value of the shunt current Is (energization current) flowing in the ground direction at the shunt resistance Rs during energization in the energization sector 4 can be acquired.

When the current energization time elapses the predetermined magnetic saturation time, the initial position detection signal generation section 131 shifts to the interruption mode, and generates the initial position detection signal Pd for changing switching elements Q2, Q3, and Q5 from on to off, whereas when the current mask time elapses the predetermined mask time (t23) from timing (t22) of turning off of the switching elements Q2, Q3, and Q5, the peak current acquiring section 132 starts the output of the pulse of the measurement trigger signal Tm to the current measurement section 16. When it is confirmed that the shunt current Is has converged to substantially zero, the peak current acquiring section 132 stops the output of the pulse of the measurement trigger signal Tm (t29). In this manner, during interruption at the energization sector 4, the peak value of the shunt current Is flowing in the inverter circuit direction at the shunt resistance Rs (kickback current) can be acquired, and the fact that the shunt current Is has returned to zero again can be determined. When it is confirmed that the shunt current Is has converged to substantially zero, the peak current acquiring section 132 notifies the initial position detection signal generation section 131 of that fact. By receiving this notification, the initial position detection signal generation section 131 can confirm that the magnitude of the kickback current has converged to zero.

Next, energization is performed in the energization mode for the energization sector 6. In the energization sector 6, as illustrated in FIG. 3, energization is performed to flow from the W-phase to the U-phase and the V-phase. More specifically, after it is confirmed that the magnitude of the kickback current has converged to zero (t29), the initial position detection signal generation section 131 generates the initial position detection signal Pd for turning on the switching elements Q2, Q4, and Q5 during the predetermined magnetic saturation time (t30 to t32), and the peak current acquiring section 132 outputs to the current measurement section 16 a pulse of the measurement trigger signal Tm at timing (t31) slightly before the current energization time elapses the predetermined magnetic saturation time in consideration of the sampling time of the A/D conversion at the current measurement section 16. In this manner, the peak value of the shunt current Is (energization current) flowing in the ground direction at the shunt resistance Rs during energization in the energization sector 6 can be acquired.

When the current energization time elapses the predetermined magnetic saturation time, the initial position detection signal generation section 131 shifts to the interruption mode, and generates the initial position detection signal Pd for changing switching elements Q2, Q4, and Q5 from on to off, whereas when the current mask time elapses the predetermined mask time (t33) from timing (t32) of turning off of the switching elements Q2, Q4, and Q5, the peak current acquiring section 132 starts the output of the pulse of the measurement trigger signal Tm to the current measurement section 16. When it is confirmed that the shunt current Is has been converged to substantially zero, the peak current acquiring section 132 stops the output of the pulse of the measurement trigger signal Tm (t39). In this manner, during interruption at the energization sector 6, the peak value of the shunt current Is flowing in the inverter circuit direction at the shunt resistance Rs (kickback current) can be acquired, and the fact that the shunt current Is has returned to zero again can be determined. When it is confirmed that the shunt current Is has converged to substantially zero, the peak current acquiring section 132 notifies the initial position detection signal generation section 131 of that fact. By receiving this notification, the initial position detection signal generation section 131 can confirm that the magnitude of the kickback current has converged to zero.

Next, energization is performed in the energization mode for the energization sector 1. In the energization sector 1, as illustrated in FIG. 3, energization is performed to flow from the U-phase and the V-phase to the W-phase. More specifically, after it is confirmed that the magnitude of the kickback current has converged to zero (t39), the initial position detection signal generation section 131 generates the initial position detection signal Pd for turning on the switching elements Q1, Q3, and Q6 during the predetermined magnetic saturation time (t40 to t42), and the peak current acquiring section 132 outputs to the current measurement section 16 a pulse of the measurement trigger signal Tm at timing (t41) slightly before the current energization time elapses the predetermined magnetic saturation time in consideration of the sampling time of the A/D conversion at the current measurement section 16. In this manner, the peak value of the shunt current Is (energization current) flowing in the ground direction at the shunt resistance Rs during energization in the energization sector 1 can be acquired.

When the current energization time elapses the predetermined magnetic saturation time, the initial position detection signal generation section 131 shifts to the interruption mode, and generates the initial position detection signal Pd for changing switching elements Q1, Q3, and Q6 from on to off, whereas when the current mask time elapses the predetermined mask time (t43) from timing (t42) of turning off of the switching elements Q1, Q3, and Q6, the peak current acquiring section 132 starts the output of the pulse of the measurement trigger signal Tm to the current measurement section 16. When it is confirmed that the shunt current Is has converged to substantially zero, the peak current acquiring section 132 stops the output of the pulse of the measurement trigger signal Tm (t49). In this manner, during interruption at the energization sector 1, the peak value of the shunt current Is flowing in the inverter circuit direction at the shunt resistance Rs (kickback current) can be acquired, and the fact that the shunt current Is has returned to zero again can be determined. When it is confirmed that the shunt current Is has converged to substantially zero, the peak current acquiring section 132 notifies the initial position detection signal generation section 131 of that fact. By receiving this notification, the initial position detection signal generation section 131 can confirm that the magnitude of the kickback current has converged to zero.

Next, energization is performed in the energization mode for the energization sector 5. In the energization sector 5, as illustrated in FIG. 3, energization is performed to flow from the V-phase to the W-phase and the U-phase. More specifically, after it is confirmed that the magnitude of the kickback current has converged to zero (t49), the initial position detection signal generation section 131 generates the initial position detection signal Pd for turning on the switching elements Q2, Q3, and Q6 during the predetermined magnetic saturation time (t50 to t52), and the peak current acquiring section 132 outputs to the current measurement section 16 a pulse of the measurement trigger signal Tm at timing (t51) slightly before the current energization time elapses the predetermined magnetic saturation time in consideration of the sampling time of the A/D conversion at the current measurement section 16. In this manner, the peak value of the shunt current Is (energization current) flowing in the ground direction at the shunt resistance Rs during energization in the energization sector 5 can be acquired.

When the current energization time elapses the predetermined magnetic saturation time, the initial position detection signal generation section 131 shifts to the interruption mode, and generates the initial position detection signal Pd for changing switching elements Q2, Q3, and Q6 from on to off, whereas when the current mask time elapses the predetermined mask time (t53) from timing (t52) of turning off of the switching elements Q2, Q3, and Q6, the peak current acquiring section 132 starts the output of the pulse of the measurement trigger signal Tm to the current measurement section 16. When it is confirmed that the shunt current Is has converged to substantially zero, the peak current acquiring section 132 stops the output of the pulse of the measurement trigger signal Tm (t59). In this manner, during interruption at the energization sector 5, the peak value of the shunt current Is flowing in the inverter circuit direction at the shunt resistance Rs (kickback current) can be acquired, and the fact that the shunt current Is has returned to zero again can be determined. When it is confirmed that the shunt current Is has converged to substantially zero, the peak current acquiring section 132 notifies the initial position detection signal generation section 131 of that fact. By receiving this notification, the initial position detection signal generation section 131 can confirm that the magnitude of the kickback current has converged to zero.

Next, energization is performed in the energization mode for the energization sector 2. In the energization sector 2, as illustrated in FIG. 3, energization is performed to flow from the W-phase and the U-phase to the V-phase. More specifically, after it is confirmed that the magnitude of the kickback current has converged to zero (t59), the initial position detection signal generation section 131 generates the initial position detection signal Pd for turning on the switching elements Q1, Q4, and Q5 during the predetermined magnetic saturation time (t60 to t62), and the peak current acquiring section 132 outputs to the current measurement section 16 a pulse of the measurement trigger signal Tm at timing (t61) slightly before the current energization time elapses the predetermined magnetic saturation time in consideration of the sampling time of the A/D conversion at the current measurement section 16. In this manner, the peak value of the shunt current Is (energization current) flowing in the ground direction at the shunt resistance Rs during energization in the energization sector 2 can be acquired.

When the current energization time elapses the predetermined magnetic saturation time, the initial position detection signal generation section 131 shifts to the interruption mode, and generates the initial position detection signal Pd for changing switching elements Q1, Q4, and Q5 from on to off, whereas when the current mask time elapses the predetermined mask time (t63) from timing (t62) of turning off of the switching elements Q1, Q4, and Q5, the peak current acquiring section 132 starts the output of the pulse of the measurement trigger signal Tm to the current measurement section 16. When it is confirmed that the shunt current Is has converged to substantially zero, the peak current acquiring section 132 stops the output of the pulse of the measurement trigger signal Tm. In this manner, during interruption at the energization sector 2, the peak value of the shunt current Is flowing in the inverter circuit direction at the shunt resistance Rs (kickback current) can be acquired, and the fact that the shunt current Is has returned to zero again can be determined.

When the current measurement has been completed in all energization sectors, the mode shifts to the free mode, and the position of the rotor is estimated based on the total current value of the peak value of the energization current and the peak value of the kickback current for each energization sector, and then the rotor initial position detection is completed.

### 2: Complementary Block System

As illustrated in FIG. 13, the complementary block system differs in that in a complementary interruption mode instead of the interruption mode of the normal system, a signal of switching the gates of the switching elements Q1 to Q6 is input such that the kickback current due to the inductive kickback is switched from via the parasitic diode of the switching element to via the on-resistance. Since other configurations are the same as the configurations of the normal system illustrated in FIG. 12, only differences from the normal system illustrated in FIG. 12 are described below.

The kickback current via the on resistance of the switching element can be achieved by turning on a switch with a complementary relationship with respect to the energization state among the switching elements Q1 to Q6 of the inverter circuit 2a. More specifically, it suffices to input the switch signal to the gates of the switching elements Q1 to Q6 so as to turn on a switch with a complementary relationship with respect to the energization state, after the dead time period to prevent upper and lower shorts of the switching element. Specifically, for the energization sector 3 that is the first energization sector, the switching elements Q2, Q3, and Q5 are turned on as for the energization sector 4 in the complementary interruption mode. In the complementary interruption mode, when it is confirmed that the shunt current Is has been substantially converged to zero, the on state of the switching elements Q2, Q3, and Q5 to set the kickback current via the on resistance of the switching element is released (turned off).

Likewise, for the energization sector 4 as the next energization sector, the switching elements Q1, Q4 and Q6 are turned on as for the energization sector 3 in the complementary interruption mode. For the energization sector 6 as the next energization sector, the switching elements Q1, Q3, and Q6 are turned on as for the energization sector 1 in the complementary interruption mode. For the energization sector 1 as the next energization sector, the switching elements Q2, Q4, and Q5 are turned on as for the energization sector 6 in the complementary interruption mode. For the energization sector 5 as the next energization sector, the switching elements Q1, Q4, and Q5 are turned on as for the energization sector 2 in the complementary interruption mode. For the energization sector 2 as the next energization sector, the switching elements Q2, Q3, and Q6 are turned on as for the energization sector 5 in the complementary interruption mode.

With this configuration, at the time of interruption, the kickback current due to the inductive kickback generated at the inverter circuit is switched from via the parasitic diode of the switching element to via the on-resistance, and thus the time the shunt current Is takes to converge to zero can be reduced. As a result, the measurement time for each one energization sector and the time required for all six-direction energizations of the rotor initial position detection can be reduced.

### 3: Low-Noise System

As illustrated in FIG. 14, in the energization mode of the normal system, a pulse with a continuous length is generated as the driving signal during the predetermined magnetic saturation time, but the energization mode of the low-noise system differs in the input of a signal for switching the gates of the switching elements Q1 to Q6 by dividing the predetermined magnetic saturation time into a plurality of short pulses so as to gradually form the magnetic field at the coils. Specifically, in the energization mode of the low noise system, energization is divided into a plurality of predetermined number of times, and performed while increasing the current flowing through the coils by repeating energization with a small current. Since other configurations are the same as the configurations of the normal system illustrated in FIG. 12, only differences from the normal system illustrated in FIG. 12 are described below. Note that the complementary interruption mode instead of the interruption mode may be used.

In FIG. 14, in the energization mode, the low-side switching element is turned on at all times while the high-side switching element is turned on/off through the PWM drive. In the energization where both the high side and the low side are simultaneously turned on, the current flows through the coils and the shunt resistance, and, in the period where the high-side switch element is off, a circulating current circulating at the low-side switching element and the coils is generated. Through this circulating current, the attenuation of the current flowing through the coils is delayed, and thus the magnetic sound can be reduced by reducing the current per energization. At this time, in FIG. 14, turning on of the low-side switching element is performed at the same time as the turning on of the high-side on, but it may be performed at the same time as the start of the energization mode (dotted line). While FIG. 14 illustrates an example with one energization sector, the driving signal is generated by dividing it into a plurality of short pulses also in other energization sectors.

With this configuration, generation of the magnetic sound “clunk” resulting from energization can be avoided. Note that in FIG. 14, in the energization mode, the high-side switching element is turned on/off through the PWM drive to turn on the low-side switching element, but this is not limitative. For example, the low-side switching element may be PWM driven with the high-side switching element turned on. Further, the duty of the PWM drive is constant in the above-described case, but this is not limitative. For example, the duty of the PWM drive may be gradually increased.

Next, the following describes the flow of the process performed by the control circuit 1 from power-on to starting the motor in the motor drive control device 10 according to the embodiment.

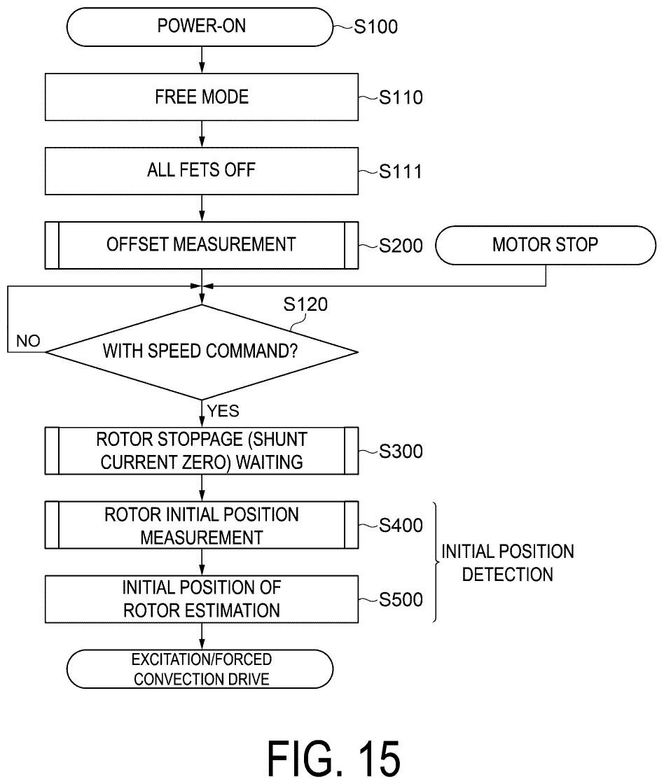

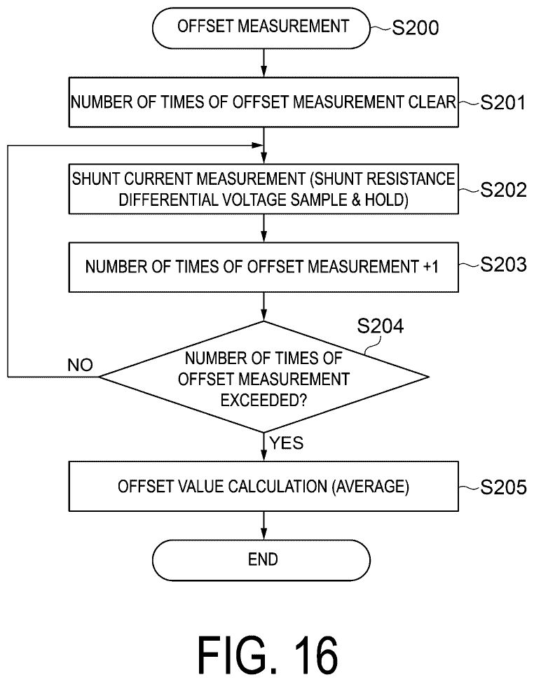

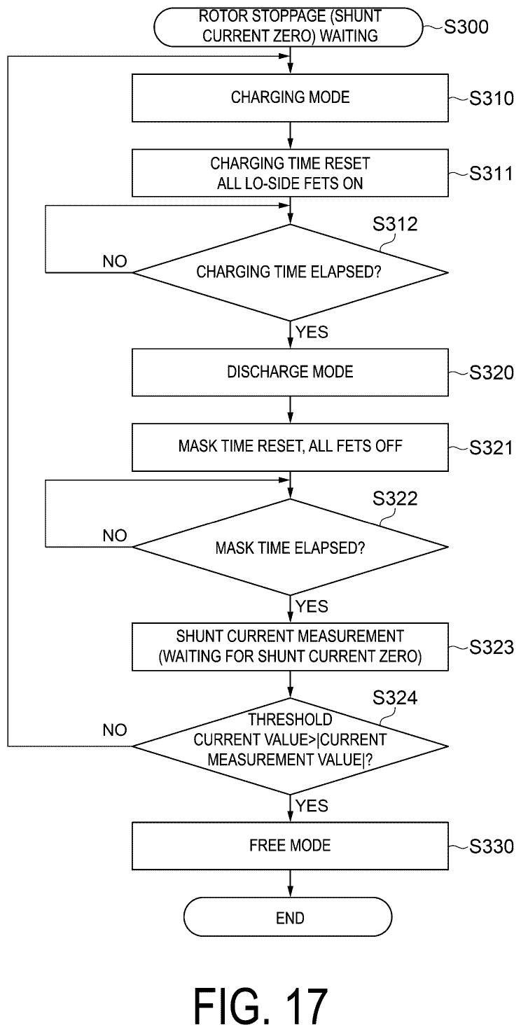

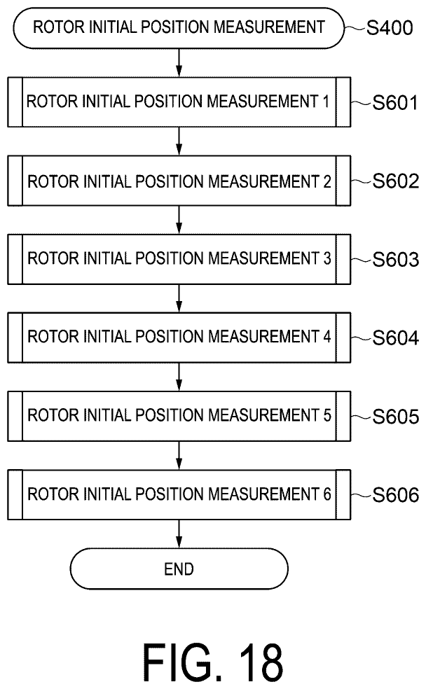

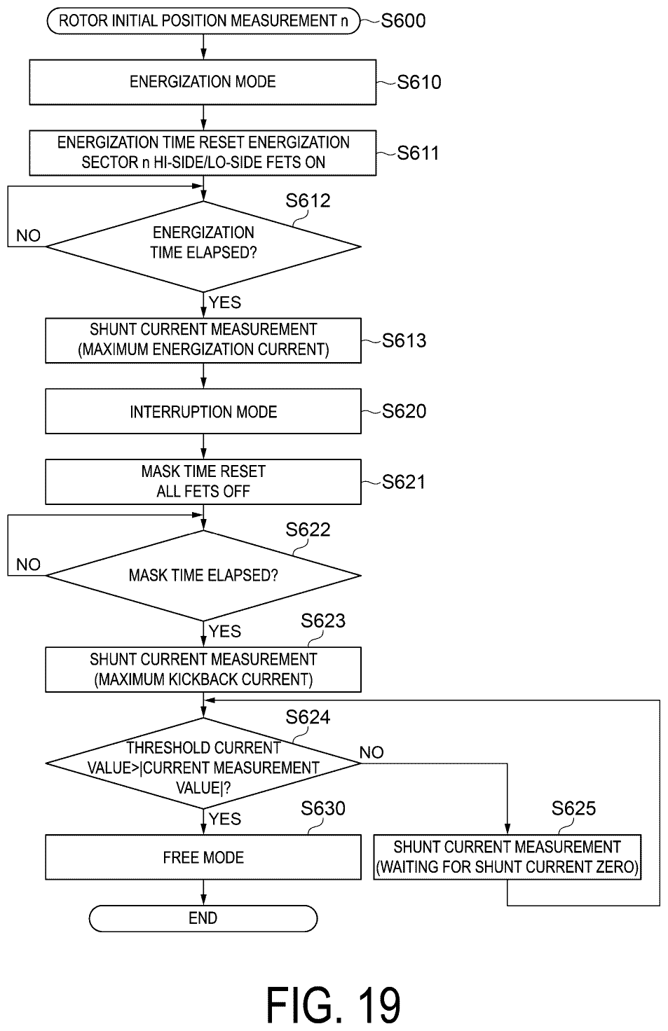

FIG. 15 is a flowchart illustrating an example of the flow of the process at the time of power-on at the control circuit 1 of the motor drive control device 10 according to the embodiment. FIG. 16 is a flowchart illustrating an example of the flow of the offset measurement process performed by the control circuit 1 of the motor drive control device 10. FIG. 17 is a flowchart illustrating an example of the flow of the rotor stoppage waiting process by the control circuit 1 of the motor drive control device 10. FIG. 18 is a flowchart illustrating an example of the flow of the rotor initial position measurement by the control circuit 1 of the motor drive control device 10. FIG. 19 is a flowchart illustrating an example of the flow of the rotor initial position measurement in an energization sector n by the control circuit 1 of the motor drive control device 10.

First, when the power is turned on in the motor drive control device 10, as illustrated in FIG. 15, the free mode is selected (step S110) at the state control section 12, and the first switching section 121a generates the first idling control signal Id1 for switching to the first switch state so as to set the switching elements Q1 to Q6 making up the inverter circuit 2a to the switch state corresponding to the free mode (all FETs off) (step S111).

In accordance with the first idling control signal Id1 generated at step S111, the state control section 12 generates the first idling control signal Id1 for switching to the first switch state for setting the switching elements Q1 to Q6 making up the inverter circuit 2a. In accordance with this first idling control signal Id1, the switching elements Q1 to Q6 making up the inverter circuit 2a is set to the first switch state as illustrated in FIG. 5.

Next, the state control section 12 executes the offset measurement process (step S200).

When the state control section 12 starts the offset measurement process, first, it clears the offset measurement counter and deactivates the offset calculator 54 as illustrated in FIG. 16 (step S201).

Next, the state control section 12 outputs the idling trigger signal Ir to control the switch of the sampling circuit 51 of the current measurement section 16, and performs A/D conversion on the current detection signal Vs output from the current detection circuit 22 to generate the current measurement value Im corresponding to the current that flows through the shunt resistance Rs (step S202). Note that the shunt current Is at this time is zero, but with the voltage that offsets the output of the amplifier of the bidirectional current detection circuit 30, the current measurement value Im is set to a value other than zero.

When the shunt current measurement of step S202 is completed, the state control section 12 increments the offset measurement counter to “+1” (step S203).

The state control section 12 determines whether the number of times the current offset measurement is performed has exceeded the predetermined number of times the offset measurement is performed by confirming the offset measurement counter (step S204).

When the number of times the current offset measurement is performed has not exceeded the predetermined number of times the offset measurement is performed (step S204: No), the process is returned to step S202. On the other hand, when the number of times of current offset measurement is performed has exceeded the predetermined number of times the offset measurement is performed (step S204: Yes), the average value of the values acquired in the measurement at step S202 is acquired as the offset value, and the offset calculator 54 is activated (step S205). Through this the offset adjustment, the current measurement value Im is zero when no current flows through the shunt resistance Rs, and the value has a positive value when a current flows in the ground direction of the shunt resistance Rs whereas the value has a negative value when a current flows in the inverter circuit direction.

Referring to FIG. 15 again, after the offset measurement of step S200, the state control section 12 determines whether the drive command acquiring section 11 has received the speed command signal Sc from a higher-level device (step S120).

When it is determined that the speed command signal Sc has not been received (step S120: No), the determination of step S120 is performed again after a predetermined time has elapsed as is.

When it is determined that the speed command signal Sc has been received (step S120: Yes), the rotor stoppage waiting is executed (step S300).

In the rotor stoppage waiting at S300, the switch state has already been set to the first switch state corresponding to the free mode, and therefore, first, the charging mode is selected at the state control section 12 as illustrated in FIG. 17 (step S310), and the second switching section 121b generates the second idling control signal Id2 for switching to the second switch state corresponding to the charging mode (all LO-side FETs on). At this time, the charging time is reset at the state control section 12 (step S311).

In accordance with the second idling control signal Id2 generated at step S310, the state control section 12 generates the second idling control signal Id2 for switching the switching elements Q1 to Q6 making up the inverter circuit 2a to the second switch state. In accordance with this second idling control signal Id2, the switching elements Q1 to Q6 making up the inverter circuit 2a are set to the second switch state as illustrated in FIG. 6, for example.

In the state control section 12, the second switching section 121b determines whether the current charging time has elapsed the predetermined charging time after the second idling control signal Id2 is generated at step S311 (step S312).

In the state control section 12, when the current charging time elapses the predetermined charging time after the second idling control signal Id2 is generated (step S312: Yes), the second switching section 121b shifts to the discharge mode in the state control section 12 (step S320), and the first switching section 121a generates the first idling control signal Id1 for switching to the first switch state corresponding to the discharge mode (all FETs off). At this time, in the state control section 12, the discharge time and mask time are reset (step S321).

The state control section 12 switches the switching elements Q1 to Q6 making up the inverter circuit 2a to the first switch state by generating the first idling control signal Id1 generated at step S321. Specifically, in accordance with this first idling control signal Id1, the switching elements Q1 to Q6 making up the inverter circuit 2a are set to the first switch state again as illustrated in FIG. 7, for example.

The state control section 12 determines whether the current mask time has elapsed the predetermined mask time (step S322). When current the mask time elapses the predetermined mask time (step S322: Yes), the state control section 12 executes the shunt current measurement process (step S323).

In the shunt current measurement process of step S323, the state control section 12 outputs the idling trigger signal Ir to the current measurement section 16 to control the switch of the sampling circuit 51 of the current measurement section 16, and generates the current measurement value Im by performing A/D conversion on the current detection signal Vs output from the current detection circuit 22 and further performing the offset adjustment. The current measurement section 16 outputs the current measurement value Im to the idling determination section 122 of the state control section 12. The current measurement value Im corresponds to a current that flows through the shunt resistance Rs of the current detection circuit 22.

The idling determination section 122 of the state control section 12 determines whether the absolute value of the current measurement value Im is smaller than the threshold current value of the idling threshold value (step S324). When determining that the absolute value of the current measurement value Im is smaller than the threshold current value (step S324: Yes), the state control section 12 terminates the rotor stoppage waiting process because the rotor is in a stopped state, and shifts to the free mode (step S330). On the other hand, when determining that the absolute value of the current measurement value Im is not smaller than the threshold current value (step S324: No), the state control section 12 executes the rotor stoppage waiting process again because the rotor is in the idling state (step S324).

Referring to FIG. 15 again, the state control section 12 sequentially executes the rotor initial position measurement (step S400) and the initial position of the rotor estimation (step S500) so as to perform the rotor initial position detection at the initial position detection section 130.

As illustrated in FIG. 18, in the rotor initial position measurement (step S400), when the initial position detection signal Pd for energization/interruption for each energization sector is generated by the initial position detection signal generation section 131 of the initial position detection section 130, the switching elements Q1 to Q6 of the inverter circuit 2a are turned on/off so as to perform energization/interruption of the coil. The peak current acquiring section 132 of the initial position detection section 130 performs current measurement for all energization sectors by acquiring the current measurement value Im of the current measurement section 16 at a predetermined timing. More specifically, in the present embodiment, the rotor initial position measurement 1 is executed for the energization sector 3 (step S601), and then sequentially, the rotor initial position measurement 2 is executed for the energization sector 4 (step S602), the rotor initial position measurement 3 is executed for the energization sector 6 (step S603), the rotor initial position measurement 4 is executed for the energization sector 1 (step S604), the rotor initial position measurement 5 is executed for the energization sector 5 (step S605), and, the rotor initial position measurement 6 is executed for the energization sector 2 (step S606).

As illustrated in FIG. 19, in the rotor initial position measurement n (step S600) that is the rotor initial position measurement in the energization sector, first, the energization mode is selected (step S610) and the energization time is reset at the initial position detection section 130, and the initial position detection signal generation section 131 generates the initial position detection signal Pd for turning on elements corresponding to the energization sector among the switching elements Q1 to Q6 so as to set the switch state corresponding to the energization sector of the rotor initial position measurement n to be measured (step S611).

The peak current acquiring section 132 determines whether the current energization time has elapsed the predetermined energization time that is the predetermined magnetic saturation time (step S612), and when the predetermined energization time has not elapsed (step S612: NO), the peak current acquiring section 132 waits until the predetermined energization time elapses. When the current energization time has elapsed the predetermined energization time (step S612: YES), the peak current acquiring section 132 performs the shunt current measurement (step S613). The peak current acquiring section 132 acquires, as the peak value of the energization current of the energization mode concerned, the current measurement value Im obtained by measuring the current flowing through the shunt resistance Rs.

When the current energization time elapses the predetermined energization time, the initial position detection signal generation section 131 shifts to the interruption mode (step S620), and generates the initial position detection signal Pd for turning off all of the switching elements Q1 to Q6 while resetting the mask time (step S621).

The peak current acquiring section 132 determines whether the current mask time has elapsed the predetermined mask time (step S622), and when the predetermined mask time has not elapsed (step S622: NO), the peak current acquiring section 132 waits until the predetermined mask time elapses. When the current mask time has elapsed the predetermined mask time (step S622: YES), the peak current acquiring section 132 performs the shunt current measurement (step S623). The peak current acquiring section 132 acquires, as the peak value of the kickback current of the interruption mode concerned, the current measurement value Im obtained by measuring the current flowing through the shunt resistance Rs.

When the current mask time elapses the predetermined mask time, the initial position detection signal generation section 131 determines whether the absolute value of the current measurement value Im obtained by measuring the current flowing through the shunt resistance Rs is smaller than the threshold current value corresponding to the zero current, as the wait for the zero current of the kickback current (step S624). When determining that the absolute value of the current measurement value Im is not smaller than the threshold current value (step S624: NO), the initial position detection signal generation section 131 performs the shunt current measurement process (step S625) because the state is a state of not converging to zero current, and the initial position detection signal generation section 131 performs the determination of step S624 again. On the other hand, when determining that the absolute value of the current measurement value Im is smaller than the threshold current value (step S624: YES), the initial position detection signal generation section 131 once shifts to the free mode of applying no signal to the switching elements Q1 to Q6 of the inverter circuit 2a because the state is a state of converging to zero current (step S630). This zero current waiting of the kickback current results in a state where no current flows through the shunt resistance Rs. Specifically, since the initial rotor position measurement in the next energization sector is not affected by the previous energization sector, correct current measurement can be performed in the rotor initial position measurement in the next energization sector, and the measurement time for each one energization sector can be reduced, and, the measurement time for all six-direction energizations of the rotor initial position measurement can be reduced.

Referring to FIG. 15 again, when the peak value of the energization current and the peak value of the kickback current are acquired for all energization sectors, the position estimation section 133 executes the initial position of the rotor estimation (step S500). When the position of the rotor is estimated through the initial position of the rotor estimation, driving of the motor through excitation, forced convection starting, and the like are executed.

The control circuit of the motor drive control device 10 according to the embodiment generates an initial position detection signal Pd for performing energization and interruption in an energization direction of the coil corresponding to an energization sector by turning on/off the high-side switches Q1, Q3, Q5 and the low-side switches Q2, Q4, Q6 of the inverter circuit 2a so as to sequentially switch the energization sector without rotating the rotor of the motor 3, acquires a peak value of an energization current that flows in the ground direction upon the energization and a peak value of a kickback current due to an inductive kickback that flows in the inverter circuit direction upon interruption of the energization for each energization sector, based on a current detected by the bidirectional current detection circuit 30 when the initial position detection signal Pd is generated, and estimates a position of the rotor based on the peak value of the energization current and the peak value of the kickback current for each energization sector.

In this manner, the motor drive control device 10 can estimate the position of the rotor in a short time, with a low-resolution current measurement device.

In the motor drive control device 10 according to the embodiment, the control circuit 1 includes: an initial position detection signal generation section 131 configured to generate the initial position detection signal Pd that is input to the inverter circuit 2a to sequentially perform energization and interruption in the energization direction of the coil for each energization sector, a peak current acquiring section 132 configured to acquire the peak value of the energization current and the peak value of the kickback current for each energization sector, and a position estimation section 133 configured to estimate the position of the rotor based on the peak value of the energization current and the peak value of the kickback current for each energization sector.

In this manner, it is possible to estimate the position of the rotor on the basis of the peak value of the kickback current and the peak value of the energization current for each energization sector that are obtained through energization/interruption by sequential switching of the energization sector without rotating the rotor of the motor 3 for the switching elements Q1 to Q6 of the inverter circuit 2a.

In the motor drive control device 10 according to the embodiment, the initial position detection signal generation section 131 generates the initial position detection signal Pd for performing energization of the next energization sector after it is confirmed that a magnitude of the kickback current has converged to zero.

In this manner, correct current measurement can be performed in the rotor initial position measurement at the next energization sector, and the time between energization sectors can be reduced, and the measurement time for all six-direction energizations of the rotor initial position measurement can be reduced.

In the motor drive control device 10 according to the embodiment, the peak current acquiring section 132 acquires the peak value of the energization current, and acquires the kickback current after a mask time has elapsed.

In this manner, the peak value of the kickback current can be acquired.

In the motor drive control device 10 according to the embodiment, the position estimation section 133 performs comparison of a total current value of the energization current and the kickback current for each energization sector, and estimates a position corresponding to the energization sector with a maximum total current value as the position of the rotor. In this manner, the position of the rotor can be estimated based on a current measurement range that is larger than that in the related art.

In the motor drive control device 10 according to the embodiment, when there are two or more energization sectors with the maximum total current value, the position estimation section 133 acquires an energization sector with the maximum peak value of the energization current flowing in the ground direction and an energization sector with the maximum peak value of the kickback current due to the inductive kickback flowing in the inverter circuit direction, and estimates the position of the rotor in accordance with the number of energization sectors acquired.

In this manner, the position of the rotor can be more reliably estimated.

In the motor drive control device 10 according to the embodiment, when there are two or more energization sectors with the maximum total current value, the position estimation section 133 further acquires, for each energization sector, differences in current between three bidirectional energizations from a total current value that is a current value of a sum of a magnitude of the peak value of the energization current flowing in the ground direction and a magnitude of the peak value of the kickback current due to the inductive kickback flowing in the inverter circuit direction, and when there is one maximum value of the differences in current between three bidirectional energizations, it is estimated that the position of the rotor is located at a position corresponding to an energization sector with a larger total current value among two energization sectors of bidirectional energization with the maximum value of the difference in current.

In this manner, the position of the rotor can be estimated.

In the motor drive control device 10 according to the embodiment, the initial position detection signal generation section 131 generates the initial position detection signal Pd set to perform the energization in the energization direction of the coil corresponding to the energization sector by dividing the energization into a plurality of predetermined number of times.

In this manner, since the current per energization can be reduced, generation of the magnetic sound “clunk” can be avoided.

In the motor drive control device 10 according to the embodiment, the initial position detection signal generation section 131 generates the initial position detection signal Pd set to turn on a switch that has a complementary relationship with respect to an energization state, of the high-side switch Q1, Q3, Q5 and the low-side switch Q2, Q4, Q6 of the inverter circuit 2a at a timing of interruption in the energization sector.

In this manner, at the time of interruption, the kickback current due to the inductive kickback generated at the inverter circuit 2a is switched from via the parasitic diode of the switching element to via the on-resistance, and thus the time for the shunt current Is to converge to zero can be reduced, and as a result, the time required for the rotor initial position detection can be reduced.

In the motor drive control device 10 according to the embodiment, the control circuit further includes: a first switching section 121a configured to switch a state from a first switch state where all of the high-side switches Q1, Q3, Q5 and the low-side switches Q2, Q4, Q6 included in the inverter circuit 2a are turned off, to a second switch state where at least two of the high-side switches Q1, Q3, Q5 or the low-side switches Q2, Q4, Q6 included in the inverter circuit 2a are turned on, a second switching section 121b configured to switch a state from the second switch state to the first switch state, and an idling determination section 122 configured to determine that the rotor of the motor is idling based on a current flowing through the shunt resistance Rs when the state is switched from the second switch state to the first switch state, wherein the control circuit generates the initial position detection signal Pd after it is confirmed at the idling determination section 122 that the rotor of the motor 3 is not idling.

In this manner, the presence/absence of the idling state of the rotor of the motor 3 can be detected, and thus the rotor stoppage waiting time can be reduced.

In the motor drive control device 10 according to the embodiment, the control circuit 1 further includes a current measurement section 16 configured to preliminarily detect, as an offset, an output signal from the bidirectional current detection circuit 30 in a state where no current flows through the shunt resistance Rs, and adjust, with the offset, a signal that is output from the bidirectional current detection circuit 30 in determination of the idling and estimation of the position of the rotor to output the signal Vs to the idling determination section 122 and the position estimation section 133.

In this manner, even when the current that flows through the shunt resistance Rs is a negative current, the value can be detected.

### Variation of Embodiments

Although the invention made by the inventors has been specifically described based on the embodiments, the invention is not limited thereto, and it goes without saying that it can be changed in various ways without departing from the gist thereof.

In addition, while the speed command signal Sc includes the target value (target rotational frequency) of the rotational speed of the motor 3 in the above-mentioned embodiment, the configuration is not limited to this. For example, the speed command signal Sc may be a torque command signal for designating the torque of the motor 3.

In addition, while the motor drive control device 10 does not use a location sensor or a measurement circuit of each phase voltage in the above-mentioned embodiment, a location sensor and/or a measurement circuit of each phase voltage may be provided. Also in this case, the location sensor and the measurement circuit of each phase voltage need not be used for detecting the rotor idling. As the location sensor, a Hall element that outputs Hall signals may be used, or other signals corresponding to the rotation position of the rotor of the motor 3 may be input as the rotation position detection signal instead of such Hall signals. For example, an encoder, a resolver, or the like may be provided such that the detection signal is input to the control circuit 1. In addition, the measurement circuit of each phase voltage may be configured such that a signal of a comparator that compares each phase voltage and the neutral point voltage or an A/D convertor is input as the rotation position detection signal.

In addition, in the above-mentioned embodiment, the control circuit 1 is not limited to the above-described circuit configuration. The control circuit 1 may employ various circuit configurations configured to achieve the objects of the present invention.

More specifically, in the current measurement section 16, an idling determination circuit using a comparator instead of the sampling circuit 51 may be provided such that a signal of an idling threshold value is output from the D/A convertor so as to determine that the rotor of the motor is idling when the maximum current detection signal Vs in the inverter circuit direction exceeds the idling threshold value, and output the idling determination signal to the state control section 12.

In addition, while the rotor idling detection process is performed after the completion of the rotor stoppage waiting process in the above-mentioned embodiment, the rotor initial position detection process may be performed assuming that the rotor is in a stopped state after waiting for the elapse of predetermined time. The rotor idling detection process for confirming the stoppage of the rotor is also not limited to the above-described method.

In addition, in the above-mentioned embodiment, the motor driving is not limited to sine wave driving. The motor drive control method is not only limited to vector control. For example, it may be 120-degree energization control.

The number of phases of the motor 3 driven by the motor drive control device 10 in the above-mentioned embodiment is not limited to 3 phases. The number of poles of the motor 3 is also not limited. The order of the energization sectors is also not limited to the above-described order.

The above-described flowcharts are specific examples, and the flowcharts are not limitative. For example, other processes may be inserted between the steps, and the processes may be executed in parallel.

### REFERENCE SIGNS LIST

1 . . . Control Circuit, 2 . . . Driving Circuit, 2a . . . Inverter Circuit, 21 . . . Pre-Drive Circuit, 22 . . . Current Detection Circuit, 3 . . . Motor, 10 . . . Motor Drive Control Device, 11 . . . Drive Command Acquiring Section, 12 . . . State Control Section, 13 . . . Vector Control Section, 14 . . . PWM Signal Generation Section, 15 . . . Timing Adjustment Section, 16 . . . Current Measurement Section, 120 . . . Idling Detection Section, 121a . . . First Switching Section, 121b . . . Second Switching Section, 122 . . . Idling Determination Section, 130 . . . Initial Position Detection Section, 131 . . . Initial Position Detection Signal Generation Section, 132 . . . Peak Current Acquiring Section, 133 . . . Position Estimation Section, 30 . . . Bidirectional Current Detection Circuit, 31 . . . Delay Circuit, 51 . . . Sampling Circuit, 52 . . . D/A Convertor, 53 . . . Comparator, 54 . . . Offset Calculator, 100 . . . Motor Unit, Q1 to Q6 . . . Switching Element, Rs . . . Shunt Resistance, Is . . . Shunt Current, Sc . . . Speed Command Signal, Sd . . . Drive Control Signal, Id . . . Idling Control Signal, Tr . . . Drive Trigger Signal, Tm . . . Measurement Trigger Signal, Ir . . . Idling Trigger Signal, Vs . . . Current Detection Signal, Im . . . Current Measurement Value, Iu, Iv, Iw . . . Winding Current, Ωref . . . Target Rotational Speed, VA, VB . . . Voltage Value, Tc . . . PWM Count Signal, St . . . Timing Signal, Vdc, Vin . . . Direct Current Power Source, Vuu, Vul, Vvu, Vvl, Vwu, Vwl . . . Driving Signal, Vout . . . Voltage Drop Signal.

1. A motor drive control device comprising:
a control circuit configured to generate a drive control signal for driving a motor including at least a coil of one phase;
a driving circuit including an inverter circuit including a high-side switch and a low-side switch connected in series and provided corresponding to a coil of each phase of the motor, the driving circuit being configured to rotate a rotor of the motor by switching an energization direction of the coil of corresponding phase by alternately turning on/off the high-side switch and the low-side switch in accordance with the drive control signal;
a shunt resistance provided between the inverter circuit and a ground; and
a bidirectional current detection circuit configured to detect a current flowing through the shunt resistance, in both a ground direction that is a direction from the inverter circuit to the ground, and in an inverter circuit direction that is a direction opposite to the ground direction, wherein
the control circuit
generates an initial position detection signal for performing energization and interruption in an energization direction of the coil corresponding to an energization sector by turning on/off the high-side switch and the low-side switch of the inverter circuit so as to sequentially switch the energization sector without rotating the rotor of the motor,
acquires a peak value of an energization current that flows in the ground direction upon the energization and a peak value of a kickback current due to an inductive kickback that flows in the inverter circuit direction upon interruption of the energization for each energization sector, based on a current detected by the bidirectional current detection circuit when the initial position detection signal is generated, and
estimates a position of the rotor based on the peak value of the energization current and the peak value of the kickback current for each energization sector.

2. The motor drive control device according to claim 1, wherein
the control circuit includes:
an initial position detection signal generation section configured to generate the initial position detection signal that is input to the inverter circuit to sequentially perform energization and interruption in the energization direction of the coil for each energization sector,
a peak current acquiring section configured to acquire the peak value of the energization current and the peak value of the kickback current for each energization sector, and
a position estimation section configured to estimate the position of the rotor based on the peak value of the energization current and the peak value of the kickback current for each energization sector.

3. The motor drive control device according to claim 2, wherein the initial position detection signal generation section generates the initial position detection signal for performing energization of a next energization sector after it is confirmed that a magnitude of the kickback current has converged to zero.

4. The motor drive control device according to claim 2, wherein the peak current acquiring section acquires the peak value of the energization current, and acquires the kickback current after a mask time has elapsed.

5. The motor drive control device according to claim 2, wherein the position estimation section performs comparison of a total current value of the energization current and the kickback current for each energization sector, and estimates a position corresponding to the energization sector with a maximum total current value as the position of the rotor.

6. The motor drive control device according to claim 5, wherein when there are two or more energization sectors with the maximum total current value, the position estimation section acquires an energization sector with a maximum peak value of the energization current flowing in the ground direction and an energization sector with a maximum peak value of the kickback current due to the inductive kickback flowing in the inverter circuit direction, and estimates the position of the rotor in accordance with the number of energization sectors acquired.

7. The motor drive control device according to claim 5, wherein when there are two or more energization sectors with the maximum total current value, the position estimation section further acquires, for each energization sector, differences in current between three bidirectional energizations from a total current value that is a current value of a sum of a magnitude of the peak value of the energization current flowing in the ground direction and a magnitude of the peak value of the kickback current due to the inductive kickback flowing in the inverter circuit direction, and when there is one maximum value of the differences in current between three bidirectional energizations, it is estimated that the position of the rotor is located at a position corresponding to an energization sector with a larger total current value among two energization sectors of bidirectional energization with the maximum value of the difference in current.

8. The motor drive control device according to claim 2, wherein the initial position detection signal generation section generates the initial position detection signal set to perform the energization in the energization direction of the coil corresponding to the energization sector by dividing the energization into a plurality of predetermined number of times.

9. The motor drive control device according to claim 2, wherein the initial position detection signal generation section generates the initial position detection signal set to turn on a switch that has a complementary relationship with respect to an energization state, among a high-side switch and a low-side switch of the inverter circuit at a timing of interruption in the energization sector.

10. The motor drive control device according to claim 1, wherein the control circuit further includes:
a first switching section configured to switch a state from a first switch state where all of the high-side switch and the low-side switch included in the inverter circuit are turned off, to a second switch state where at least two of the high-side switch or the low-side switch included in the inverter circuit are turned on,
a second switching section configured to switch a state from the second switch state to the first switch state, and
an idling determination section configured to determine that the rotor of the motor is idling based on a current flowing through the shunt resistance when the state is switched from the second switch state to the first switch state, wherein
the control circuit generates the initial position detection signal after it is confirmed at the idling determination section that the rotor of the motor is not idling.

11. The motor drive control device according to claim 10, wherein
the control circuit further includes a position estimation section configured to estimate the position of the rotor based on the peak value of the energization current and the peak value of the kickback current for each energization sector, and
the control circuit further includes a current measurement section configured to preliminarily detect, as an offset, an output signal from the bidirectional current detection circuit in a state where no current flows through the shunt resistance, adjust, with the offset, a signal that is output from the bidirectional current detection circuit in determination of the idling and estimation of the position of the rotor, and output the signal to the idling determination section and the position estimation section. w

12. An initial position detection method for a rotor configured to be executed in a motor drive control device including:
a control circuit configured to generate a drive control signal for driving a motor including at least a coil of one phase;
a driving circuit including an inverter circuit including a high-side switch and a low-side switch connected in series and provided corresponding to a coil of each phase of the motor, the driving circuit being configured to rotate a rotor of the motor by switching an energization direction of the coil of corresponding phase by alternately turning on/off the high-side switch and the low-side switch in accordance with the drive control signal;
a shunt resistance provided between the inverter circuit and a ground; and
a bidirectional current detection circuit configured to detect a current flowing through the shunt resistance, in both a ground direction that is a direction from the inverter circuit to the ground, and in an inverter circuit direction that is a direction opposite to the ground direction, the method comprising:
generating an initial position detection signal for performing energization and interruption in an energization direction of the coil corresponding to an energization sector by turning on/off the high-side switch and the low-side switch of the inverter circuit so as to sequentially switch the energization sector without rotating the rotor of the motor,
acquiring a peak value of an energization current that flows in the ground direction upon the energization and a peak value of a kickback current due to an inductive kickback that flows in the inverter circuit direction upon interruption of the energization for each energization sector, based on a current detected by the bidirectional current detection circuit when the initial position detection signal is generated, and
estimating a position of the rotor based on the peak value of the energization current and the peak value of the kickback current for each energization sector.
